(19) United States
(12) Patent Application Publication
(10) Pub. No.: US 2021/0112287 A1
(43) Pub. Date: Apr. 15, 2021

(54) METHOD AND APPARATUS FOR TRANSMITTING OR RECEIVING METADATA OF AUDIO IN WIRELESS COMMUNICATION SYSTEM

(71) Applicant: LG ELECTRONICS INC., Seoul (KR)

(72) Inventors: Tungchin Lee, Seoul (KR); Sejin Oh, Seoul (KR); Sooyeon Lee, Seoul (KR)

(21) Appl. No.: 17/046,578

(22) PCT Filed: Apr. 10, 2019
(86) PCT No.: PCT/KR2019/004256

§ 371 Date: Oct. 9, 2020

(30) Foreign Application Priority Data
Apr. 11, 2018 (LR) 10-2018-0042186

(51) Int. Cl. H04N 21/233; H04N 21/439; H04N 21/81; H04N 21/434; H04N 21/2187; H04R 1/08; G10L 19/00

(52) U.S. Cl. CPC H04N 21/233; H04N 21/439; H04N 21/8146; G10L 19/00; H04N 21/2187; H04R 1/08; H04N 21/434

(57) ABSTRACT

One embodiment of the present invention provides a communication method of an audio data transmitting apparatus in a wireless communication system, the method comprising the steps of: acquiring information on at least one audio signal on which sound source information processing is to be performed; generating metadata relating to the sound source information processing, on the basis of the information on the at least one audio signal; and transmitting the metadata relating to the sound source information processing to an audio data receiving apparatus.

### TECHNICAL FIELD

The present disclosure relates to metadata about audio, and more particularly, to a method and apparatus for transmitting or receiving metadata about audio in a wireless communication system.

### BACKGROUND ART

A virtual reality (VR) system allows a user to experience an electronically projected environment. The system for providing VR content may be further improved to provide higher quality images and stereophonic sound. The VR system may allow a user to interactively consume VR contents.

With the increasing demand for VR or AR content, there is an increasing need for a method of efficiently signaling information about audio for generating VR content between terminals, between a terminal and a network (or server), or between networks.

### DISCLOSURE

### Technical Problem

An object of the present disclosure is to provide a method and apparatus for transmitting and receiving metadata about audio in a wireless communication system.

Another object of the present disclosure is to provide a terminal or network (or server) for transmitting and receiving metadata about sound information processing in a wireless communication system, and an operation method thereof.

Another object of the present disclosure is to provide an audio data reception apparatus for processing sound information while transmitting/receiving metadata about audio to/from at least one audio data transmission apparatus, and an operation method thereof.

Another object of the present disclosure is to provide an audio data transmission apparatus for transmitting/receiving metadata about audio to/from at least one audio data reception apparatus based on at least one acquired audio signal, and an operation method thereof.

### Technical Solution

In one aspect of the present disclosure, provided herein is a method for performing communication by an audio data transmission apparatus in a wireless communication system. The method may include acquiring information on at least one audio signal to be subjected to sound information processing, generating metadata about the sound information processing based on the information on the at least one audio signal, and transmitting the metadata about the sound information processing to an audio data reception apparatus.

In another aspect of the present disclosure, provided herein is an audio data transmission apparatus for performing communication in a wireless communication system. The audio data transmission apparatus may include an audio data acquirer configured to acquire information on at least one sound to be subjected to sound information processing, a metadata processor configured to generate metadata about the sound information processing based on the information on the at least one sound, and a transmitter configured to transmit the metadata about the sound information processing to an audio data reception apparatus.

In another aspect of the present disclosure, provided herein is a method for performing communication by an audio data reception apparatus in a wireless communication system. The method may include receiving metadata about sound information processing and at least one audio signal from at least one audio data transmission apparatus, and processing the at least one audio signal based on the metadata about the sound information processing, wherein the metadata about the sound information processing may contain sound source environment information including information on a space for the at least one audio signal and information on both ears of at least one user of the audio data reception apparatus.

In another aspect of the present disclosure, provided herein is an audio data reception apparatus for performing communication in a wireless communication system. The audio data reception apparatus may include a receiver configured to receive metadata about sound information processing and at least one audio signal from at least one audio data transmission apparatus, and an audio signal processor configured to process the at least one audio signal based on the metadata about the sound information processing, wherein the metadata about the sound information processing may contain sound source environment information including information on a space for the at least one audio signal and information on both ears of at least one user of the audio data reception apparatus.

### Advantageous Effects

According to the present disclosure, information about sound information processing may be efficiently signaled between terminals, between a terminal and a network (or server), or between networks.

According to the present disclosure, VR content may be efficiently signaled between terminals, between a terminal and a network (or server), or between networks in a wireless communication system.

According to the present disclosure, 3DoF, 3DoF+ or 6DoF media information may be efficiently signaled between terminals, between a terminal and a network (or server), or between networks in a wireless communication system.

According to the present disclosure, in providing a 360-degree audio streaming service, information related to sound information processing may be signaled when network-based sound information processing for uplink is performed.

According to the present disclosure, in providing a 360-degree audio streaming service, multiple streams for uplink may be packed into one stream and signaled.

According to the present disclosure, SIP signaling for negotiation between a FLUS source and a FLUS sink may be performed for a 360-degree audio uplink service.

According to the present disclosure, in providing a 360-degree audio streaming service, information necessary may be transmitted and received between the FLUS source and the FLUS sink for the uplink.

According to the present disclosure, in providing a 360-degree audio streaming service, necessary information may be generated between the FLUS source and the FLUS sink for uplink.

### DESCRIPTION OF DRAWINGS

FIG. 1 is a diagram showing an overall architecture for providing 360-degree content according to an embodiment.

FIGS. 2 and 3 illustrate a structure of a media file according to according to some embodiments.

FIG. 4 illustrates an example of the overall operation of a DASH-based adaptive streaming model.

FIGS. 5A and 5B are diagrams schematically illustrating the configuration of an audio data transmission apparatus and an audio data reception apparatus according to an embodiment.

FIGS. 6A and 6B are diagrams schematically illustrating the configuration of an audio data transmission apparatus and an audio data reception apparatus according to another embodiment.

FIG. 7 is a diagram illustrating the concept of aircraft principal axes for describing a 3D space according an embodiment.

FIG. 8 is a diagram schematically illustrating an exemplary architecture for an MTSI service.

FIG. 9 is a diagram schematically illustrating an exemplary configuration of a terminal providing an MTSI service.

FIGS. 10 to 15 are diagrams schematically illustrating examples of a FLUS architecture.

FIG. 16 is a diagram schematically illustrating an exemplary configuration of a FLUS session.

FIGS. 17A to 17D are diagrams illustrating examples in which a FLUS source and a FLUS sink transmit and receive signals related to a FLUS session according to some embodiments.

FIGS. 18A to 18F are diagrams illustrating examples of a process in which a FLUS source and a FLUS sink generate 360-degree audio while transmitting and receiving metadata about sound source processing according to some embodiments.

FIG. 19 is a flowchart illustrating a method of operating an audio data transmission apparatus according to an embodiment.

FIG. 20 is a block diagram illustrating the configuration of the audio data transmission apparatus according to the embodiment.

FIG. 21 is a flowchart illustrating a method of operating an audio data reception apparatus according to an embodiment.

FIG. 22 is a block diagram illustrating the configuration of the audio data reception apparatus according to the embodiment.

### BEST MODE

According to an embodiment of the present disclosure, provided herein is a method for performing communication by an audio data transmission apparatus in a wireless communication system. The method may include acquiring information about at least one audio signal to be subjected to sound information processing, generating metadata about the sound information processing based on the information on the at least one audio signal, and transmitting the metadata about the sound information processing to an audio data reception apparatus.

### [Mode]

The technical features described below may be used in a communication standard by the 3rd generation partnership project (3GPP) standardization organization, or a communication standard by the institute of electrical and electronics engineers (IEEE) standardization organization. For example, communication standards by the 3GPP standardization organization may include long term evolution (LTE) and/or evolution of LTE systems. Evolution of the LTE system may include LTE-A (advanced), LTE-A Pro and/or 5G new radio (NR). A wireless communication device according to an embodiment of the present disclosure may be applied to, for example, a technology based on SA4 of 3GPP. The communication standard by the IEEE standardization organization may include a wireless local area network (WLAN) system such as IEEE 802.11a/b/g/n/ac/ax. The above-described systems may be used for downlink (DL)-based and/or uplink (UL)-based communications.

The present disclosure may be subjected to various changes and may have various embodiments, and specific embodiments will be described in detail with reference to the accompanying drawings. However, this is not intended to limit the disclosure to the specific embodiments. Terms used in this specification are merely adopted to explain specific embodiments, and are not intended to limit the technical spirit of the present disclosure. A singular expression includes a plural expression unless the context clearly indicates otherwise. In In this specification, the term “include” or “have” is intended to indicate that characteristics, figures, steps, operations, constituents, and components disclosed in the specification or combinations thereof exist, and should be understood as not precluding the existence or addition of one or more other characteristics, figures, steps, operations, constituents, components, or combinations thereof.

Although individual elements described in the present disclosure are independently shown in the drawings for convenience of description of different functions, this does not mean that the elements are implemented in hardware or software elements separate from each other. For example, two or more of the elements may be combined to form one element, or one element may be divided into a plurality of elements. Embodiments in which respective elements are integrated and/or separated are also within the scope of the present disclosure without departing from the essence of the present disclosure.

Hereinafter, exemplary embodiments of the present disclosure will be described in detail with reference to the accompanying drawings. The same reference numerals will be used for the same components in the drawings, and redundant descriptions of the same components are omitted.

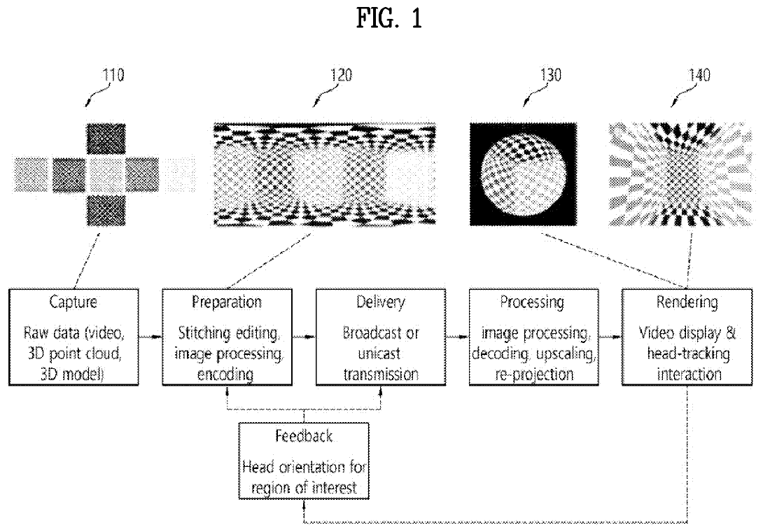

FIG. 1 is a diagram showing an overall architecture for providing 360 content according to an embodiment.

In this specification, the term “image” may be a concept including a still image and a video that is a set of a series of still images over time. The term “video” does not necessarily mean a set of a series of still images over time. In some cases, a still image may be interpreted as a concept included in a video.

In order to provide virtual reality (VR) to users, a method of providing 360 content may be considered. Here, the 360 content may be referred to as 3 Degrees of Freedom (3DoF) content, and VR may refer to a technique or an environment for replicating a real or virtual environment. VR may artificially provide sensuous experiences to users and thus users may experience electronically projected environments therethrough.

360 content may refer to all content for realizing and providing VR, and may include 360-degree video and/or 360-degree audio. The 360-degree video and/or 360-degree audio may also be referred to as 3D video and/or 3D audio 360-degree video may refer to video or image content which is needed to provide VR and is captured or reproduced in all directions (360 degrees) at the same time. Hereinafter, 360-degree video may refer to 360-degree video. 360-degree video may refer to a video or image presented in various types of 3D space according to a 3D model. For example, 360-degree video may be presented on a spherical surface. 360-degree audio may be audio content for providing VR and may refer to spatial audio content which may make an audio generation source recognized as being located in a specific 3D space. 360-degree audio may also be referred to as 3D audio. 360 content may be generated, processed and transmitted to users, and the users may consume VR experiences using the 360 content. The 360-degree video may be called omnidirectional video, and the 360 image may be called omnidirectional image.

To provide a 360-degree video, a 360-degree video may be initially captured using one or more cameras. The captured 360-degree video may be transmitted through a series of processes, and the data received on the receiving side may be processed into the original 360-degree video and rendered. Then, the 360-degree video may be provided to a user.

Specifically, the entire processes for providing 360-degree video may include a capture process, a preparation process, a transmission process, a processing process, a rendering process and/or a feedback process.

The capture process may refer to a process of capturing an images or video for each of multiple viewpoints through one or more cameras. Image/video data as shown in part 110 of FIG. 1 may be generated through the capture process. Each plane in part 110 of FIG. 1 may refer to an image/video for each viewpoint. The captured images/videos may be called raw data. In the capture process, metadata related to the capture may be generated.

A special camera for VR may be used for the capture. According to an embodiment, when a 360-degree video for a virtual space generated using a computer is to be provided, the capture operation through an actual camera may not be performed. In this case, the capture process may be replaced by a process of generating related data.

The preparation process may be a process of processing the captured images/videos and the metadata generated in the capture process. In the preparation process, the captured images/videos may be subjected to stitching, projection, region-wise packing, and/or encoding

First, each image/video may be subjected to the stitching process. The stitching process may be a process of connecting the captured images/videos to create a single panoramic image/video or a spherical image/video.

The stitched images/videos may be subjected to the projection process. In the projection process, the stitched images/videos may be projected onto a 2D image. The 2D image may be referred to as a 2D image frame depending on the context. Projection onto a 2D image may be referred to as mapping to the 2D image. The projected image/video data may take the form of a 2D image as shown in part 120 of FIG. 1.

The video data projected onto the 2D image may be subjected to the region-wise packing process in order to increase video coding efficiency. The region-wise packing may refer to a process of dividing the video data projected onto the 2D image into regions and processing the regions. Here, the regions may refer to regions obtained by dividing the 2D image onto which 360-degree video data is projected. According to an embodiment, such regions may be distinguished by dividing the 2D image equally or randomly. According to an embodiment, the regions may be divided according to a projection scheme. The region-wise packing process may be optional, and may thus be omitted from the preparation process.

According to an embodiment, this processing process may include a process of rotating the regions or rearranging the regions on the 2D image in order to increase video coding efficiency. For example, the regions may be rotated such that specific sides of the regions are positioned close to each other. Thereby, coding efficiency may be increased.

According to an embodiment, the processing process may include a process of increasing or decreasing the resolution of a specific region in order to differentiate between the resolutions for the regions of the 360-degree video. For example, the resolution of regions corresponding to a relatively important area of the 360-degree video may be increased over the resolution of the other regions. The video data projected onto the 2D image or the region-wise packed video data may be subjected to the encoding process that employs a video codec.

According to an embodiment, the preparation process may further include an editing process. In the editing process, the image/video data before or after the projection may be edited. In the preparation process, metadata for stitching/projection/encoding/editing may be generated. In addition, metadata about the initial viewpoint or the region of interest (ROI) of the video data projected onto the 2D image may be generated.

The transmission process may be a process of processing and transmitting the image/video data and the metadata obtained through the preparation process. Processing according to any transport protocol may be performed for transmission. The data that has been processed for transmission may be delivered over a broadcast network and/or broadband. The data may be delivered to a receiving side in an on-demand manner. The receiving side may receive the data through various paths.

The processing process may refer to a process of decoding the received data and re-projecting the projected image/video data onto a 3D model. In this process, the image/video data projected onto 2D images may be re-projected onto a 3D space. This process may be referred to as mapping or projection depending on the context. Here, the shape of the 3D space to which the data is mapped may depend on the 3D model. For example, 3D models may include a sphere, a cube, a cylinder and a pyramid.

According to an embodiment, the processing process may further include an editing process and an up-scaling process. In the editing process, the image/video data before or after the re-projection may be edited. When the image/video data has a reduced size, the size of the image/video data may be increased by up-scaling the samples in the up-scaling process. The size may be reduced through down-scaling, when necessary.

The rendering process may refer to a process of rendering and displaying the image/video data re-projected onto the 3D space. The re-projection and rendering may be collectively expressed as rendering on a 3D model. The image/video re-projected (or rendered) on the 3D model may take the form as shown in part 130 of FIG. 1. The part 130 of FIG. 1 corresponds to a case where the image/video data is re-projected onto the 3D model of sphere. A user may view a part of the regions of the rendered image/video through a VR display or the like. Here, the region viewed by the user may take the form as shown in part 140 of FIG. 1.

The feedback process may refer to a process of delivering various types of feedback information which may be acquired in the display process to a transmitting side. Through the feedback process, interactivity may be provided in 360-degree video consumption. According to an embodiment, head orientation information, viewport information indicating a region currently viewed by the user, and the like may be delivered to the transmitting side in the feedback process. According to an embodiment, the user may interact with content realized in a VR environment. In this case, information related to the interaction may be delivered to the transmitting side or a service provider in the feedback process. In an embodiment, the feedback process may be skipped.

The head orientation information may refer to information about the position, angle and motion of the user's head. Based on this information, information about a region currently viewed by the user in the 360-degree video, namely, viewport information may be calculated.

The viewport information may be information about a region currently viewed by the user in the 360-degree video. Gaze analysis may be performed based on this information to check how the user consumes the 360-degree video and how long the user gazes at a region of the 360-degree video. The gaze analysis may be performed at the receiving side and a result of the analysis may be delivered to the transmitting side on a feedback channel. A device such as a VR display may extract a viewport region based on the position/orientation of the user's head, vertical or horizontal field of view (FOV) information supported by the device, and the like.

According to an embodiment, the aforementioned feedback information may be not only delivered to the transmitting side but also consumed on the receiving side. That is, the decoding, re-projection and rendering processes may be performed on the receiving side based on the aforementioned feedback information. For example, only 360-degree video corresponding to a region currently viewed by the user may be preferentially decoded and rendered based on the head orientation information and/or the viewport information.

Here, the viewport or the viewport region may refer to a region of 360-degree video currently viewed by the user. A viewpoint may be a point which is viewed by the user in a 360-degree video and may represent a center point of the viewport region. That is, a viewport is a region centered on a viewpoint, and the size and shape of the region may be determined by FOV, which will be described later.

In the above-described architecture for providing 360-degree video, image/video data which is subjected to a series of processes of capture/projection/encoding/transmission/decoding/re-projection/rendering may be called 360-degree video data. The term “360-degree video data” may be used as a concept including metadata or signaling information related to such image/video data.

To store and transmit media data such as the audio or video data described above, a standardized media file format may be defined. According to an embodiment, a media file may have a file format based on the ISO base media file format (ISO BMFF).

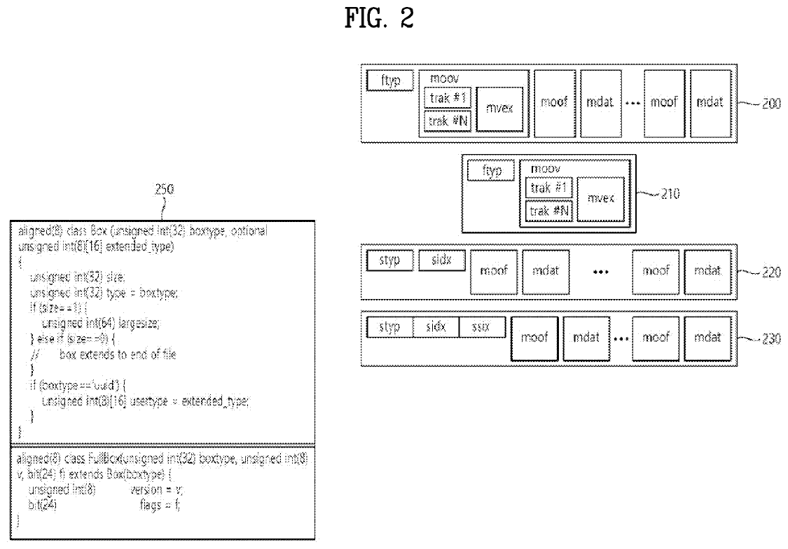

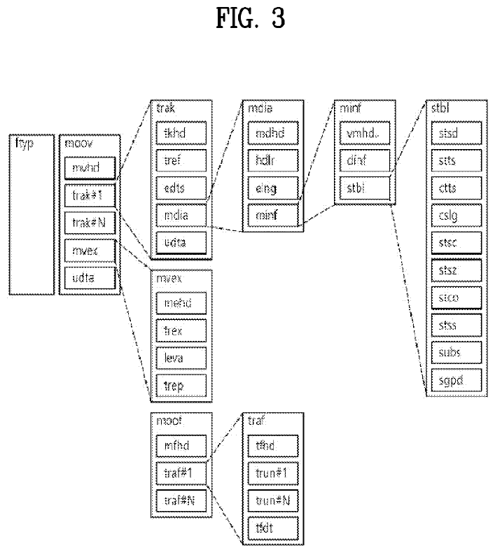

FIGS. 2 and 3 illustrate a structure of a media file according to some embodiment of the present disclosure.

A media file according to an embodiment may include at least one box. Here, the box may be a data block or object containing media data or metadata related to the media data. The boxes may be arranged in a hierarchical structure. Thus, the data may be classified according to the boxes and the media file may take a form suitable for storage and/or transmission of large media data. In addition, the media file may have a structure which facilitates access to media information as in the case where the user moves to a specific point in the media content.

The media file according to the embodiment may include an ftyp box, a moov box and/or an mdat box.

The ftyp box (file type box) may provide information related to a file type or compatibility of a media file. The ftyp box may include configuration version information about the media data of the media file. A decoder may identify a media file with reference to the ftyp box.

The moov box (movie box) may include metadata about the media data of the media file. The moov box may serve as a container for all metadata. The moov box may be a box at the highest level among the metadata related boxes. According to an embodiment, only one moov box may be present in the media file.

The mdat box (media data box) may a box that contains actual media data of the media file. The media data may include audio samples and/or video samples and the mdat box may serve as a container to contain such media samples.

According to an embodiment, the moov box may further include an mvhd box, a trak box and/or an mvex box as sub-boxes.

The mvhd box (movie header box) may contain media presentation related information about the media data included in the corresponding media file. That is, the mvhd box may contain information such as a media generation time, change time, time standard and period of the media presentation.

The trak box (track box) may provide information related to a track of the media data. The trak box may contain information such as stream related information, presentation related information, and access related information about an audio track or a video track. Multiple trak boxes may be provided depending on the number of tracks.

According to an embodiment, the trak box may include a tkhd box (track header box) as a sub-box. The tkhd box may contain information about a track indicated by the trak box. The tkhd box may contain information such as a generation time, change time and track identifier of the track.

The mvex box (movie extend box) may indicate that the media file may have a moof box, which will be described later. The moov boxes may need to be scanned to recognize all media samples of a specific track.

According to an embodiment, the media file according to the present disclosure may be divided into multiple fragments (200). Accordingly, the media file may be segmented and stored or transmitted. The media data (mdat box) of the media file may be divided into multiple fragments and each of the fragments may include a moof box and a divided mdat box. According to an embodiment, the information in the ftyp box and/or the moov box may be needed to utilize the fragments.

The moof box (movie fragment box) may provide metadata about the media data of a corresponding fragment. The moof box may be a box at the highest layer among the boxes related to the metadata of the corresponding fragment.

The mdat box (media data box) may contain actual media data as described above. The mdat box may contain media samples of the media data corresponding to each fragment.

According to an embodiment, the moof box may include an mfhd box and/or a traf box as sub-boxes.

The mfhd box (movie fragment header box) may contain information related to correlation between multiple divided fragments. The mfhd box may include a sequence number to indicate a sequential position of the media data of the corresponding fragment among the divided data. In addition, it may be checked whether there is missing data among the divided data, based on the mfhd box.

The traf box (track fragment box) may contain information about a corresponding track fragment. The traf box may provide metadata about a divided track fragment included in the fragment. The traf box may provide metadata so as to decode/play media samples in the track fragment. Multiple traf boxes may be provided depending on the number of track fragments.

According to an embodiment, the traf box described above may include a tfhd box and/or a trun box as sub-boxes.

The tfhd box (track fragment header box) may contain header information about the corresponding track fragment. The tfhd box may provide information such as a default sample size, period, offset and identifier for the media samples of the track fragment indicated by the traf box described above.

The trun box (track fragment run box) may contain information related to the corresponding track fragment. The trun box may contain information such as a period, size and play timing of each media sample.

The media file or the fragments of the media file may be processed into segments and transmitted. The segments may include an initialization segment and/or a media segment.

The file of the illustrated embodiment 210 may be a file containing information related to initialization of the media decoder except the media data. This file may correspond to the initialization segment described above. The initialization segment may include the ftyp box and/or the moov box described above.

The file of the illustrated embodiment 220 may be a file including the above-described fragments. For example, this file may correspond to the media segment described above. The media segment may include the moof box and/or the mdat box described above. The media segment may further include an styp box and/or an sidx box.

The styp box (segment type box) may provide information for identifying media data of a divided fragment. The styp box may serve as the above-described ftyp box for the divided fragment. According to an embodiment, the styp box may have the same format as the ftyp box.

The sidx box (segment index box) may provide information indicating an index for a divided fragment. Accordingly, the sequential position of the divided fragment may be indicated.

According to an embodiment 230, an ssix box may be further provided. When a segment is further divided into sub-segments, the ssix box (sub-segment index box) may provide information indicating indexes of the sub-segments.

The boxes in the media file may further contain further extended information based on a box as illustrated in an embodiment 250 or a FullBox. In this embodiment, the size field and the largesize field may indicate the length of a corresponding box in bytes. The version field may indicate the version of a corresponding box format. The Type field may indicate the type or identifier of the box. The flags field may indicate a flag related to the box.

The fields (attributes) for 360-degree video according to the embodiment may be carried in a DASH-based adaptive streaming model.

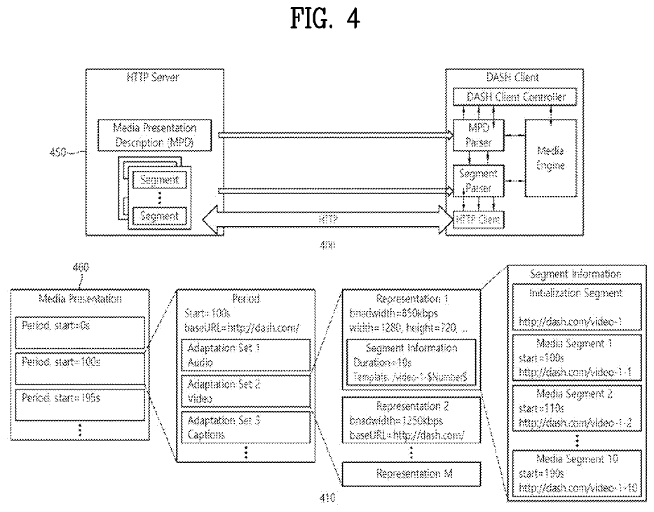

FIG. 4 illustrates an example of the overall operation of a DASH-based adaptive streaming model.

A DASH-based adaptive streaming model according to an embodiment 400 shown in the figure describes operations between an HTTP server and a DASH client. Here, DASH (dynamic adaptive streaming over HTTP) is a protocol for supporting HTTP-based adaptive streaming and may dynamically support streaming according to the network condition. Accordingly, AV content may be seamlessly played.

Initially, the DASH client may acquire an MPD. The MPD may be delivered from a service provider such as the HTTP server. The DASH client may make a request to the server for segments described in the MPD, based on the information for access to the segments. The request may be made based on the network condition.

After acquiring the segments, the DASH client may process the segments through a media engine and display the processed segments on a screen. The DASH client may request and acquire necessary segments by reflecting the playback time and/or the network condition in real time (Adaptive Streaming) Accordingly, content may be seamlessly played.

The MPD (media presentation description) is a file containing detailed information allowing the DASH client to dynamically acquire segments, and may be represented in an XML format.

A DASH client controller may generate a command for requesting the MPD and/or segments considering the network condition. In addition, the DASH client controller may perform a control operation such that an internal block such as the media engine may use the acquired information.

An MPD parser may parse the acquired MPD in real time. Accordingly, the DASH client controller may generate a command for acquiring a necessary segment.

A segment parser may parse the acquired segment in real time. Internal blocks such as the media engine may perform a specific operation according to the information contained in the segment.

The HTTP client may make a request to the HTTP server for a necessary MPD and/or segments. In addition, the HTTP client may deliver the MPD and/or segments acquired from the server to the MPD parser or the segment parser.

The media engine may display content on the screen based on the media data contained in the segments. In this operation, the information in the MPD may be used.

The DASH data model may have a hierarchical structure 410. Media presentation may be described by the MPD. The MPD may describe a time sequence of multiple periods constituting the media presentation. A period may represent one section of media content.

In one period, data may be included in adaptation sets. An adaptation set may be a set of multiple media content components which may be exchanged. An adaption may include a set of representations. A representation may correspond to a media content component. In one representation, content may be temporally divided into multiple segments, which may be intended for appropriate accessibility and delivery. To access each segment, a URL of each segment may be provided.

The MPD may provide information related to media presentation. The period element, the adaptation set element, and the representation element may describe a corresponding period, a corresponding adaptation set, and a corresponding representation, respectively. A representation may be divided into sub-representations. The sub-representation element may describe a corresponding sub-representation.

Here, common attributes/elements may be defined. These may be applied to (included in) an adaptation set, a representation, or a sub-representation. The common attributes/elements may include EssentialProperty and/or SupplementalProperty.

The EssentialProperty may be information including elements regarded as essential elements in processing data related to the corresponding media presentation. The SupplementalProperty may be information including elements which may be used in processing the data related to the corresponding media presentation. In an embodiment, descriptors which will be described later may be defined in the EssentialProperty and/or the SupplementalProperty when delivered through an MPD.

The description given above with reference to FIGS. 1 to 4 relates to 3D video and 3D audio for implementing VR or AR content. Hereinafter, a process of processing 3D audio data in relation to embodiments according to the present disclosure will be mainly described.

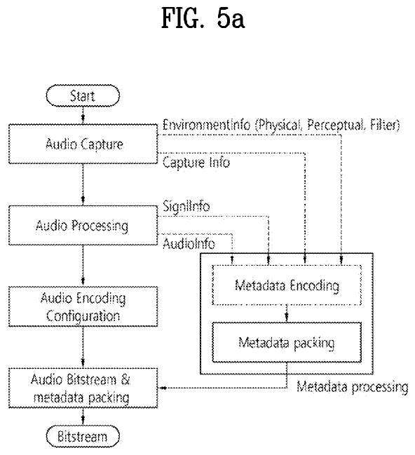

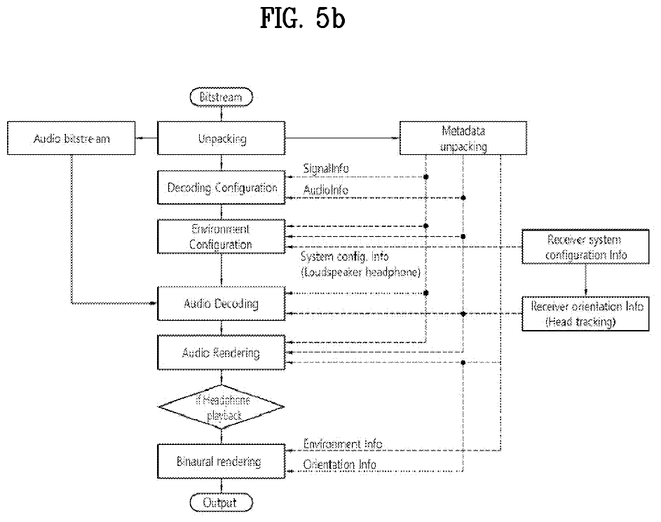

FIGS. 5A and 5B are diagrams schematically illustrating the configuration of an audio data transmission apparatus and an audio data reception apparatus according to another embodiment.

FIG. 5A schematically illustrates a process in which audio data is processed by an audio data transmission apparatus.

An audio capture terminal may capture signals reproduced or generated in an arbitrary environment, using multiple microphones. In one embodiment, microphone may be classified into a sound field microphone and a general recording microphone. The sound field microphone is suitable for rendering of a scene played in an arbitrary environment because a single microphone device is equipped with multiple small microphones, and may be used in creating an HOA type signal. The recording microphone is may be used in creating a channel type or object type signal. Information about the type of microphones employed, the number of microphones used for recording, and the like may be recorded and generated by a content creator in the audio capture process. Information about the characteristics of the environment for recording may also be recorded in this process. The audio capture terminal may record characteristics information and environment information about the microphones in CaptureInfo and EnvironmentInfo, respectively, and extract metadata.

The captured signals may be input to an audio processing terminal. The audio processing terminal mix and process the captured signals to generate audio signals of a channel, object, or HOA type. As described above, sound recorded based on the sound field microphone may be used in generating an HOA signal, and sound captured based on the recording microphone may be used in generating a channel or object signal. How to use the captured sound may be determined by a content creator that produces the sound. In one example, when a mono channel signal is to be generated from a single sound, it may be created by properly adjusting only the volume of the sound. When a stereo channel signal is to be generated, the captured sound may be duplicated as two signals, and directionality may be given to the signals by applying a panning technique to each of the signals. The audio processing terminal may extract AudioInfo and SignalInfo as audio-related information and signal-related information (e.g., sampling rate, bit size, etc.), all of which may be produced according to the intention of the content creator.

The signal generated by the audio processing terminal may be input to an audio encoding terminal and then encoded and bit packed. In addition, metadata generated by the audio content creator may be encoded by a metadata encoding terminal, if necessary, or may be directly packed by a metadata packing terminal. The packed metadata may be repacked in an audio bitstream & metadata packing terminal to generate a final bitstream, and the generated bitstream may be transmitted to an audio data reception apparatus.

FIG. 5A schematically illustrates a process in which audio data is processed by an audio data reception apparatus.

The audio data reception apparatus of FIG. 5B may unpack the received bitstream and separate the same into metadata and an audio bitstream. Next, in the decoding configuration process, characteristics of the audio signal may be identified by referring to SignalInfo and AudioInfo metadata. In the environment configuration process, how to decode the signal may be determined. This operation may be performed in consideration of the transmitted metadata and the playback environment information of the audio data reception apparatus. For example, when the transmitted audio bitstream is a signal consisting of 22.2 channels as a result of referring to AudioInfo, while the playback environment of the audio data reception apparatus is only 10.2 channel speakers, all related information may be aggregated in the environment configuration process to reconstruct audio signals according to the final playback environment. In this case, system configuration information (System Config. Info), which is information related to the playback environment of the audio data reception apparatus, may be used in the process.

The audio bitstream separated in the unpacking process may be decoded by an audio decoding terminal. The number of decoded audio signals may be equal to the number of audio signals input to the audio encoding terminal. Next, the decoded audio signals may be rendered by an audio rendering terminal according to the final playback environment. That is, as in the previous example, when 22.2 channel signals are to be reproduced in a 10.2 channel environment, the number of output signals may be changed by downmixing from the 22.2 channel to the 10.2 channel. In addition, when a user wears a device configured to receive head tracking information, that is, when the audio rendering terminal can receive orientationInfo, cross reference to tracking information by the audio rendering terminal may be allowed. Thereby, a higher level 3D audio signal may be experienced. Next, when the audio signals are to be reproduced through headphones in place of a speaker, the audio signals may be delivered to a binaural rendering terminal. Then, EnvironmentInfo in the transmitted metadata may be used. The binaural rendering terminal may receive or model an appropriate filter by referring to the EnvironmentInfo, and then filter the audio signals through the filter, thereby outputting a final signal. When the user is wearing a device configured to receive tracking information, the user may experience higher-level 3D audio, as in the speaker environment.

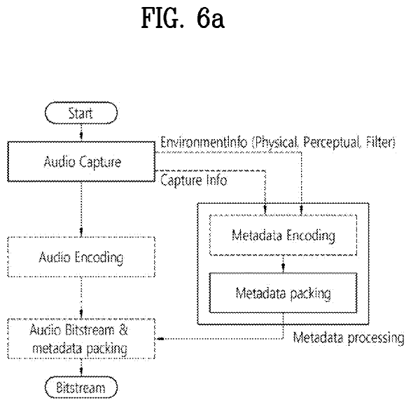

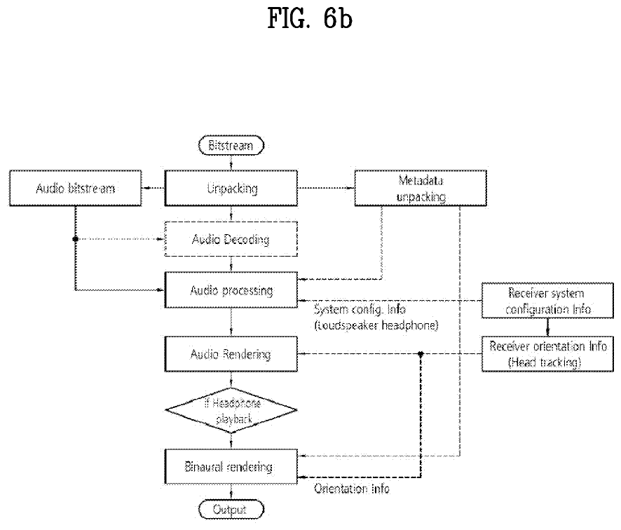

FIGS. 6A and 6B are diagrams schematically illustrating the configuration of an audio data transmission apparatus and an audio data reception apparatus according to another embodiment.

In the above-described transmission and reception processes of FIGS. 5A and 5B, the captured audio signal is pre-made as a channel, object, or HOA type signal at the transmitting terminal, and thus additional capture information may not be required at the receiving terminal. However, when the captured sound is transmitted to the receiving terminal without a separate processing process as shown in FIGS. 6A and 6B, it is necessary to use CaptureInfo of metadata. Metadata packing may be performed on the metadata information (CaptureInfo, EnvironmentInfo) generated in the audio capture process of FIG. 6A, and the captured sound may be delivered directly to the audio bitstream & metadata packing terminal, or may be encoded by the audio encoding terminal to generate and transmit an audio bitstream. The audio bitstream & metadata packing terminal may generate a bitstream by packing all the delivered information, and then deliver the same to the receiver.

The audio data reception apparatus of FIG. 6B may first separate the audio bitstream from the metadata through an unpacking terminal. In the case where the sound captured by the audio data transmission apparatus is in the encoded state, decoding may be performed first. Next, audio processing may be performed by referring to the playback environment information of the audio data reception apparatus as system configuration information (System Config. Info). That is, channel, object, or HOA type signals may be generated from the captured sound. Then, the generated signals may be rendered according to the playback environment. When played back through headphones, an output signal may be generated by performing a binaural rendering process with reference to EnvironmentInfo in the metadata. When the user is wearing a device configured to receive tracking information, that is, when the orientationInfo can be referred to in the rendering process, the user may experience higher-level 3D audio in a speaker or headphone environment.

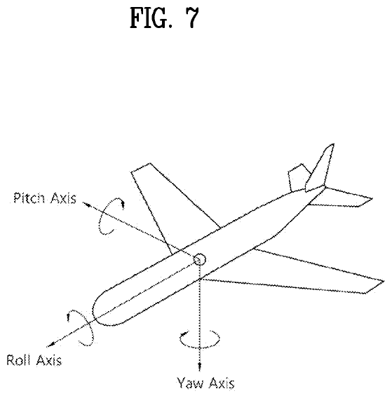

FIG. 7 is a diagram illustrating the concept of aircraft principal axes for describing a 3D space according an embodiment.

In the present disclosure, the concept of aircraft principal axes may be used to express a specific point, position, direction, spacing, area, and the like in a 3D space. That is, in the present disclosure, the concept of aircraft principal axes may be used to describe the concept of 3D space given before or after projection and to perform signaling therefor. According to an embodiment, a method based on the Cartesian coordinate system using X, Y, and Z axes or a spherical coordinate system may be used.

An aircraft may rotate freely in three dimensions. The axes constituting the three dimensions are referred to as a pitch axis, a yaw axis, and a roll axis, respectively. In this specification, these axes may be simply expressed as pitch, yaw, and roll or as a pitch direction, a yaw direction, a roll direction.

In one example, the roll axis may correspond to the X-axis or back-to-front axis of the Cartesian coordinate system. Alternatively, the roll axis may be an axis extending from the front nose to the tail of the aircraft in the concept of aircraft principal axes, and rotation in the roll direction may refer to rotation about the roll axis. The range of roll values indicating the angle rotated about the roll axis may be from −180 degrees to 180 degrees, and the boundary values of −180 degrees and 180 degrees may be included in the range of roll values.

In another example, the pitch axis may correspond to the Y-axis or side-to-side axis of the Cartesian coordinate system. Alternatively, the pitch axis may refer to an axis around which the front nose of the aircraft rotates upward/downward. In the illustrated concept of aircraft principal axes, the pitch axis may refer to an axis extending from one wing to the other wing of the aircraft. The range of pitch values, which represent the angle of rotation about the pitch axis, may be between −90 degrees and 90 degrees, and the boundary values of −90 degrees and 90 degrees may be included in the range of pitch values.

In another example, the yaw axis may correspond to the Z axis or vertical axis of the Cartesian coordinate system. Alternatively, the yaw axis may refer to a reference axis around which the front nose of the aircraft rotates leftward/rightward. In the illustrated concept of aircraft principal axes, the yaw axis may refer to an axis extending from the top to the bottom of the aircraft. The range of yaw values, which represent the angle of rotation about the yaw axis, may be from −180 degrees to 180 degrees, and the boundary values of −180 degrees and 180 degrees may be included in the range of yaw values.

In 3D space according to an embodiment, a center point that is a reference for determining a yaw axis, a pitch axis, and a roll axis may not be static.

As described above, the 3D space in the present disclosure may be described based on the concept of pitch, yaw, and roll.

As described above, the video data projected on a 2D image may be subjected to the region-wise packing process in order to increase video coding efficiency and the like. The region-wise packing process may refer to a process of dividing the video data projected onto the 2D image into regions and processing the same according to the regions. The regions may refer to regions obtained by dividing the 2D image onto which 360-degree video data is projected. The divided regions of the 2D image may be distinguished by projection schemes. Here, the 2D image may be called a video frame or a frame.

In this regard, the present disclosure proposes metadata for the region-wise packing process according to a projection scheme and a method of signaling the metadata. The region-wise packing process may be more efficiently performed based on the metadata.

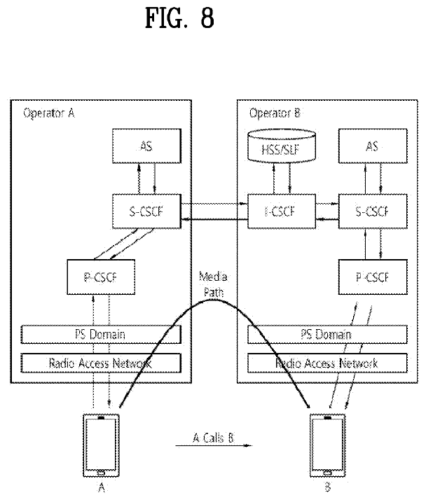

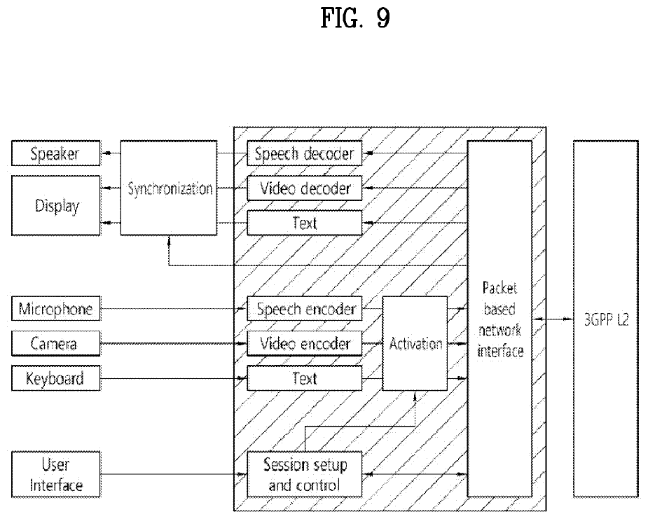

FIG. 8 is a diagram schematically illustrating an exemplary architecture for an MTSI service, and FIG. 9 is a diagram schematically illustrating an exemplary configuration of a terminal providing an MTSI service.

Multimedia Telephony Service for IMS (MTSI) represents a telephony service that establishes multimedia communication between user equipments (UEs) or terminals that are present in an operator network that is based on the IP Multimedia Subsystem (IMS) function. UEs may access the IMS based on a fixed access network or a 3GPP access network. The MTSI may include a procedure for interaction between different clients and a network, use components of various kinds of media (e.g., video, audio, text, etc.) within the IMS, and dynamically add or delete media components during a session.

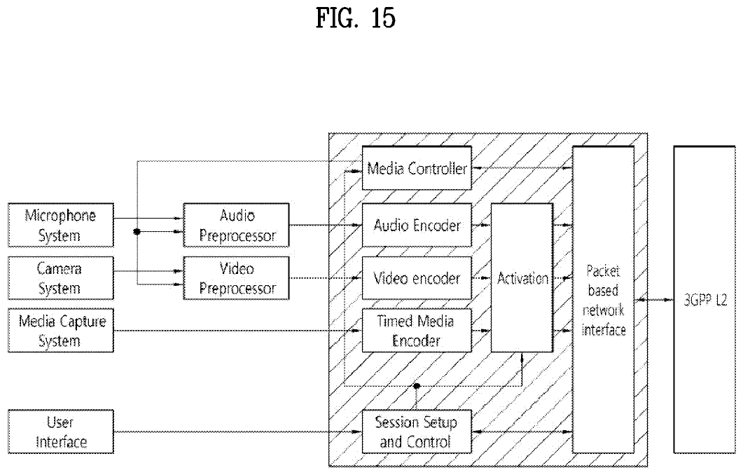

FIG. 15 illustrates an example in which MTSI clients A and B connected over two different networks perform communication using a 3GPP access including an MTSI service.

MTSI client A may establish a network environment in Operator A while transmitting/receiving network information such as a network address and a port translation function to/from the proxy call session control function (P-CSCF) of the IMS over a radio access network. A service call session control function (S-CSCF) is used to handle an actual session state on the network, and an application server (AS) may control actual dynamic server content to be delivered to Operator B based on the middleware that executes an application on the device of an actual client.

When the I-CSCF of Operator B receives actual dynamic server content from Operator A, the S-CECF of Operator B may control the session state on the network, including the role of indicating the direction of the IMS connection. At this time, the MTSI client B connected to Operator B network may perform video, audio, and text communication based on the network access information defined through the P-CSCF. The MTSI service may perform interactivity such as addition and deletion of individual media stream setup, control and media components between clients based on SDP and SDPCapNeg in SIP invitation, which is used for capability negotiation and media stream setup, and individual, control and media components. Media translation may include not only an operation of processing coded media received from a network, but also an operation of encapsulating the coded media in a transport protocol.

When the fixed access point uses the MTSI service, as shown in FIG. 9, the MTSI service is applied in the operations of encoding and packetizing a media session obtained through a microphone, a camera, or a keyboard, transmitting the media session to a network, receiving and decoding the media session though the 3GPP Layer 2 protocol, and transmitting the same to a speaker and a display.

However, in the case of communication based on FIGS. 8 and 9, which are based on the MTSI service, it is difficult to apply the service when 3DoF, 3DoF+ or 6DoF media information for generating and transmitting one or more 360-degree videos (or 360 images) captured by two or more cameras is transmitted and received.

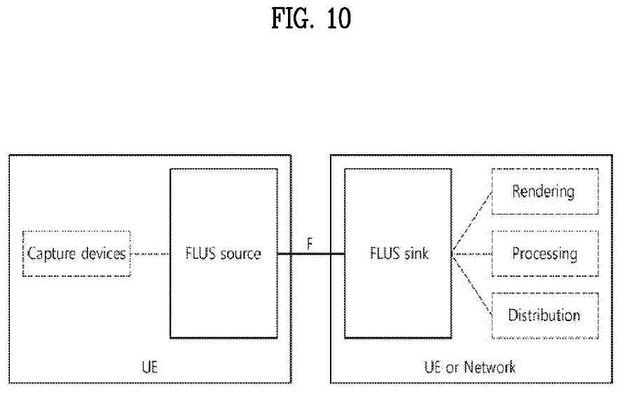

FIGS. 10 to 15 are diagrams schematically illustrating examples of a FLUS architecture.

FIG. 10 illustrates an example of communication performed between UEs or between a UE and a network based on Framework for Live Uplink Streaming (FLUS) in a wireless communication system. The FLUS source and the FLUS sink may transmit and receive data to and from each other using an F reference point.

In this specification, “FLUS source” may refer to a device configured to transmit data to an FLUS sink through the F reference point based on FLUS. However, the FLUS source does not always transmit data to the FLUS sink. In some cases, the FLUS source may receive data from the FLUS sink through the F reference point. The FLUS source may be construed as a device identical/similar to the audio data transmission apparatus, transmission terminal, source or 360-degree audio transmission apparatus described herein, as including the audio data transmission apparatus, transmission terminal, source or 360-degree audio transmission apparatus, or as being included in the audio data transmission apparatus, transmission terminal, source or 360-degree audio transmission apparatus. The FLUS source may be, for example, a UE, a network, a server, a cloud server, a set-top box (STB), a base station, a PC, a desktop, a laptop, a camera, a camcorder, a TV, an audio device, or a recorder, and may be an element or module included in the illustrated apparatuses. Further, devices similar to the illustrated apparatuses may also operate as a FLUS source. Examples of the FLUS source are not limited thereto.

In this specification, “FLUS sink” may refer to a device configured to receive data from an FLUS source through the F reference point based on FLUS. However, the FLUS sink does not always receive data from the FLUS source. In some cases, the FLUS sink may transmit data to the FLUS source through the F reference point. The FLUS sink may be construed as a device identical/similar to the audio data reception apparatus, transmission terminal, sink, or 360-degree audio data reception apparatus described herein, as including the audio data reception apparatus, transmission terminal, sink, or 360-degree audio data reception apparatus, or as being included in the audio data reception apparatus, transmission terminal, sink, or 360-degree audio data reception apparatus. The FLUS sink may be, for example, a network, a server, a cloud server, an STB, a base station, a PC, a desktop, a laptop, a camera, a camcorder, a TV, or the like, and may be an element or module included in the illustrated apparatuses. Further, devices similar to the illustrated apparatuses may also operate as a FLUS sink. Examples of the FLUS sink are not limited thereto.

While the FLUS source and the capture devices are illustrated in FIG. 10 as constituting one UE, embodiments are not limited thereto. The FLUS source may include capture devices. In addition, a FLUS source including the capture devices may be a UE. Alternatively, the capture devices may not be included in the UE, and may transmit media information to the UE. The number of capture devices may be greater than or equal to one.

While the FLUS sink, a rendering module (or unit), a processing module (or unit), and a distribution module (or unit) are illustrated in FIG. 10 as constituting one UE or network, embodiments are not limited thereto. The FLUS sink may include at least one of the rendering module, the processing module, and the distribution module. In addition, a FLUS sink including at least one of the rendering module, the processing module, and the distribution module may be a UE or a network. Alternatively, at least one of the rendering module, the processing module, and the distribution module may not be included in the UE or the network, and the FLUS sink may transmit media information to at least one of the rendering module, the processing module, and the distribution module. At least one rendering module, at least one processing module, and at least one distribution module may be configured. In some cases, some of the modules may not be provided.

In one example, the FLUS sink may operate as a media gateway function (MGW) and/or application function (AF).

In FIG. 10, the F reference point, which connects the FLUS source and the FLUS sink, may allow the FLUS source to create and control a single FLUS session. In addition, the F reference point may allow the FLUS sink to authenticate and authorize the FLUS source. Further, the F reference point may support security protection functions of the FLUS control plane F-C and the FLUS user plane F-U.

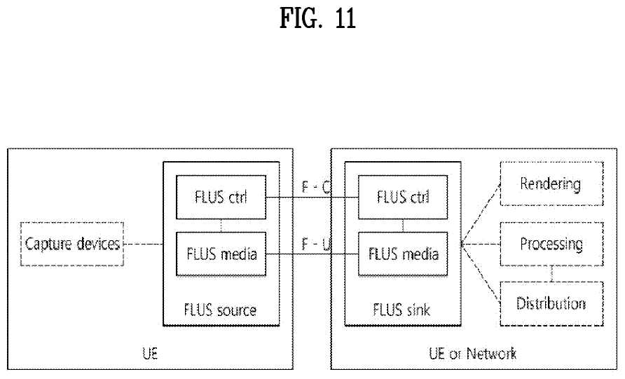

Referring to FIG. 11, the FLUS source and the FLUS sink may each include a FLUS ctrl module. The FLUS ctrl modules of the FLUS source and the FLUS sink may be connected via the F-C. The FLUS ctrl modules and the F-C may provide a function for the FLUS sink to perform downstream distribution on the uploaded media, provide media instantiation selection, and support configuration of the static metadata of the session. In one example, when the FLUS sink can perform only rendering, the F-C may not be present.

In one embodiment, the F-C may be used to create and control a FLUS session. The F-C may be used for the FLUS source to select a FLUS media instance, such as MTSI, provide static metadata around a media session, or select and configure processing and distribution functions.

The FLUS media instance may be defined as part of the FLUS session. In some cases, the F-U may include a media stream creation procedure, and multiple media streams may be generated for one FLUS session.

The media stream may include a media component for a single content type, such as audio, video, or text, or a media component for multiple different content types, such as audio and video. A FLUS session may be configured with multiple identical content types. For example, a FLUS session may be configured with multiple media streams for video.

Referring to FIG. 11, the FLUS source and the FLUS sink may each include a FLUS media module. The FLUS media modules of the FLUS source and the FLUS sink may be connected through the F-U. The FLUS media modules and the F-U may provide functions of creation of one or more media sessions and transmission of media data over a media stream. In some cases, a media session creation protocol (e.g., IMS session setup for an FLUS instance based on MTSI) may be required.

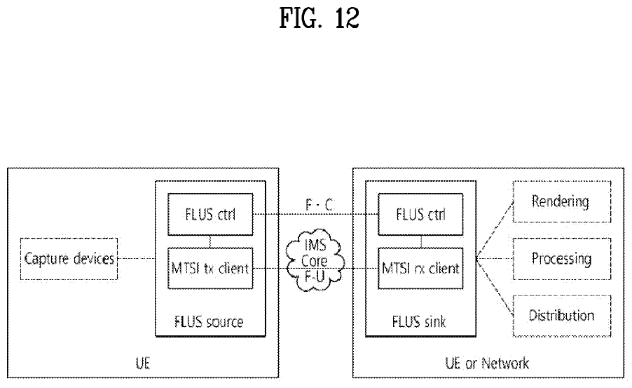

FIG. 12 may correspond to an example of an architecture of uplink streaming for MTSI. The FLUS source may include an MTSI transmission client (MTSI tx client), and the FLUS sink may include an MTSI reception client (MTSI rx client). The MTSI tx client and MTSI rx client may be interconnected through the IMS core F-U.

The MTSI tx client may operate as a FLUS transmission component included in the FLUS source, and the MTSI rx client may operate as a FLUS reception component included in the FLUS sink.

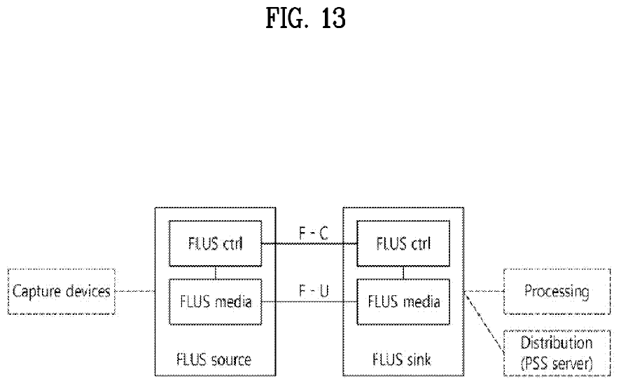

FIG. 13 may correspond to an example of an architecture of uplink streaming for a packet-switched streaming service (PSS). A PSS content source may be positioned on the UE side and may include a FLUS source. In the PSS, FLUS media may be converted into PSS media. The PSS media may be generated by a content source and uploaded directly to a PSS server.

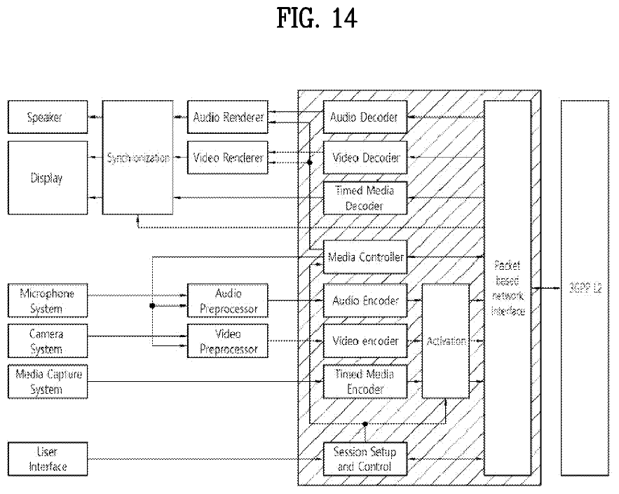

FIG. 14 may correspond to an example of functional components of the FLUS source and the FLUS sink. In one example, the hatched portion in FIG. 14 may represent a single device. FIG. 14 is merely an example, and it will be readily understood by those skilled in the art that embodiments of the present disclosure are not limited to FIG. 14.

Referring to FIG. 14, audio content, image content, and video content may be encoded through an audio encoder and a video encoder. A time media encoder may encode, for example, text media, graphic media, and the like.

FIG. 15 may correspond to an example of a FLUS source for uplink media transmission. In one example, the hatched portion in FIG. 15 may represent a single device. That is, a single device may perform the function of the FLUS source. However, FIG. 15 is merely an example, and it will be readily understood by those skilled in the art that embodiments of the present disclosure are not limited to FIG. 15.

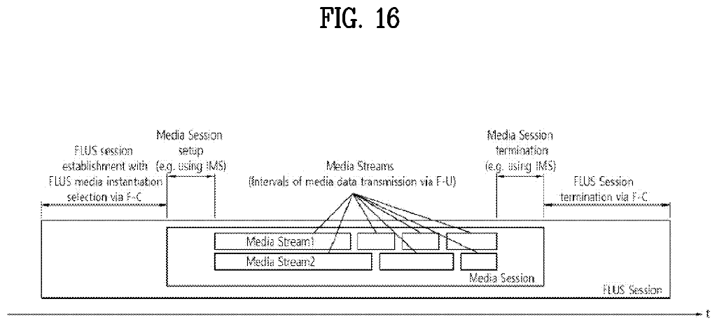

FIG. 16 is a diagram schematically illustrating an exemplary configuration of a FLUS session.

The FLUS session may include one or more media streams. The media stream included in the FLUS session is within a time range in which the FLUS session is present. When the media stream is activated, the FLUS source may transmit media content to the FLUS sink. In rest realization of HTTPS of the F-C, the FLUS session may be present even when an FLUS media instance is not selected.

Referring to FIG. 16, a single media session including two media streams included in one FLUS session is illustrated. In one example, when the FLUS sink is positioned in a UE and the UE directly renders received media content, the FLUS session may be FFS. In another example, when the FLUS sink is positioned in a network and provides media gateway functionality, the FLUS session may be used to select a FLUS media session instance and may control sub-functions related to processing and distribution.

Media session creation may depend on realization of a FLUS media sub-function. For example, when MTSI is used as a FLUS media instance and RTP is used as a media streaming transport protocol, a separate session creation protocol may be required. For example, when HTTPS-based streaming is used as a media streaming protocol, media streams may be directly installed without using other protocols. The F-C may be used to receive an ingestion point for the HTTPS stream.

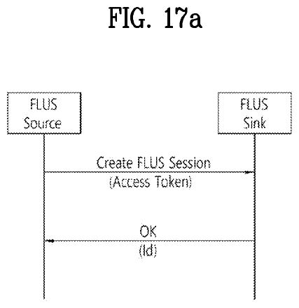

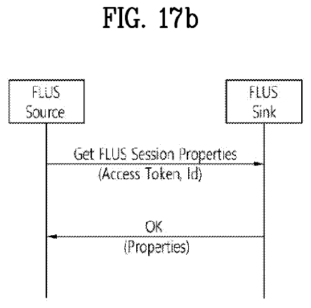

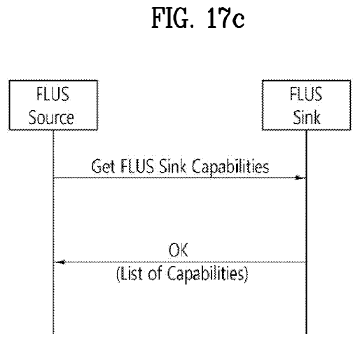

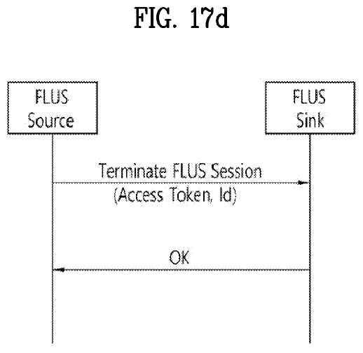

FIGS. 17A to 17D are diagrams illustrating examples in which a FLUS source and a FLUS sink transmit and receive signals related to a FLUS session according to some embodiments.

FIG. 17A may correspond to an example in which a FLUS session is created between a FLUS source and a FLUS sink.

The FLUS source may need information for establishing an F-C connection to a FLUS sink. For example, the FLUS source may require SIP-URI or HTTP URL to establish an F-C connection to the FLUS sink.

To create a FLUS session, the FLUS source may provide a valid access token to the FLUS sink. When the FLUS session is successfully created, the FLUS sink may transmit resource ID information of the FLUS session to the FLUS source. FLUS session configuration properties and FLUS media instance selection may be added in a subsequent procedure. The FLUS session configuration properties may be extracted or changed in the subsequent procedure.

FIG. 17B may correspond to an example of acquiring FLUS session configuration properties.

The FLUS source may transmit at least one of the FLUS sink access token and the ID information to acquire FLUS session configuration properties. The FLUS sink may transmit the FLUS session configuration properties to the FLUS source in response to the at least one of the access token and the ID information received from the FLUS source.

In RESTful architecture design, an HTTP resource may be created. The FLUS session may be updated after the creation. In one example, a media session instance may be selected.

The FLUS session update may include, for example, selection of a media session instance such as MTSI, provision of specific metadata about the session such as the session name, copyright information, and descriptions, processing operations for each media stream including transcoding, repacking and mixing of the input media streams, and the distribution operation of each media stream. Storage of data may include, for example, CDN-based functions, Xmb for Xmb-u parameters such as BM-SC Push URL or address, and a social media platform for Push parameters and session credential.

FIG. 17C may correspond to an example of FLUS sink capability discovery.

FLUS sink capabilities may include, for example, processing capabilities and distribution capabilities.

The processing capabilities may include, for example, supported input formats, codecs and codec profiles/levels, include transcoding with formats, output codecs, codec profiles/levels, bitrates, and the like, and reformatting with output formats, include combination of input media streams such as network-based stitching and mixing. Objects included in the processing capability are not limited thereto.

The distribution capabilities include, for example, storage capabilities, CDN-based capabilities, CDN-based server base URLs, forwarding, a supported forwarding protocol, and a supported security principle. Objects included in the distribution capabilities are not limited thereto.

FIG. 17D may correspond to an example of FLUS session termination.

The FLUS source may terminate the FLUS session, data according to the FLUS session, and the active media session. Alternatively, the FLUS session may be automatically terminated when the last media session of the FLUS session is terminated.

As illustrated in FIG. 17D, the FLUS source may transmit a Terminate FLUS Session command to the FLUS sink. For example, the FLUS source may transmit an access token and ID information to the FLUS sink to terminate the FLUS session. Upon receiving the Terminate FLUS Session command from the FLUS source, the FLUS sink may terminate the FLUS session, terminate all active media streams included in the FLUS session, and transmit, to the FLUS source, an acknowledgement that the Terminate FLUS Session command has been effectively received.

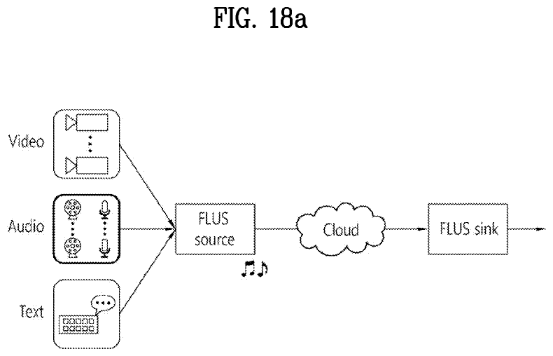

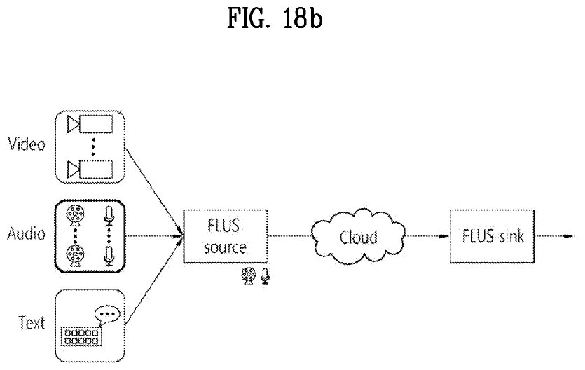

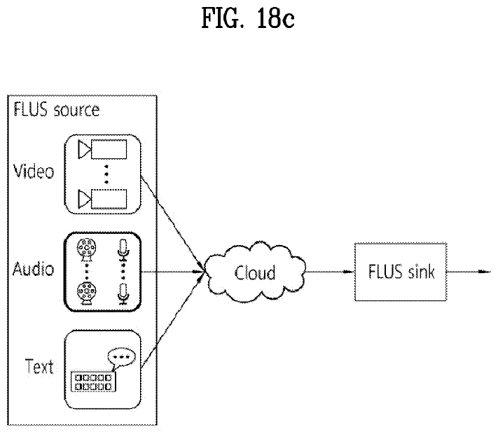

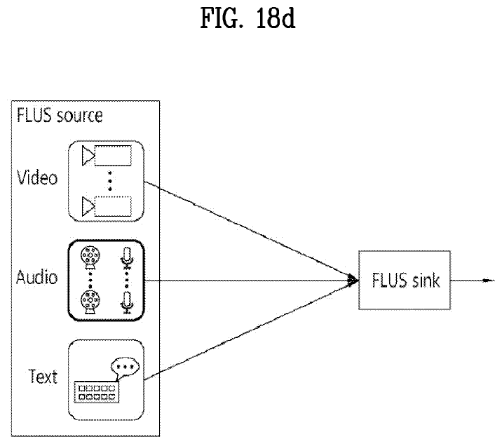

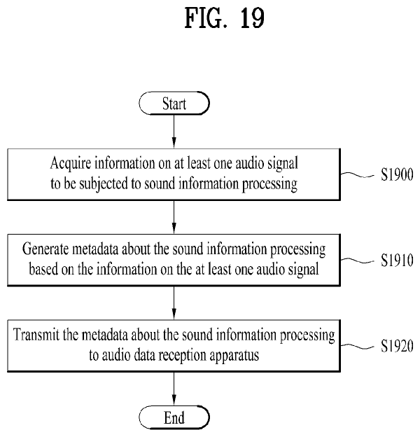

FIGS. 18A to 18F are diagrams illustrating examples of a process in which a FLUS source and a FLUS sink generate 360-degree audio while transmitting and receiving metadata about sound source processing according to some embodiments.

In this specification, the term “media acquisition module” may refer to a module or device for acquiring media such as images (videos), audio, and text. The media acquisition module may also be referred to as a capture device. The media acquisition module may be a concept including an image acquisition module, an audio acquisition module, and a text acquisition module. The image acquisition module may be, for example, a camera, a camcorder, or a UE, or the like. The audio acquisition module may be a microphone, a recording microphone, a sound field microphone, a UE, or the like. The text acquisition module may be a keyboard, a microphone, a PC, a UE, or the like. Objects included in the media acquisition module are not limited to the above-described example, and examples of each of the image acquisition module, audio acquisition module, and text acquisition module included in the media acquisition module are not limited to the above-described example.

A FLUS source according to an embodiment may acquire audio information (or sound information) for generating 360-degree audio from at least one media acquisition module. In some cases, the media acquisition module may be a FLUS source. According to various examples as illustrated in FIGS. 18A to 18D, the media information acquired by the FLUS source may be delivered to the FLUS sink. As a result, at least one piece of 360-degree audio content may be generated.

As used herein, “sound information processing” may represent a process of deriving at least one channel signal, object signal, or HOA signal according to the type and number of media acquisition modules based on at least one audio signal or at least one voice. The sound information processing may also be referred to as sound engineering, sound processing, or the like. In an example, the sound information processing may be a concept including audio information processing and voice information processing.

FIG. 18A illustrates a process in which audio signals captured through a media acquisition module are transmitted to a FLUS source to perform sound information processing. As a result of the sound information processing, a plurality of channel, object, or HOA-type signals may be formed according to the type and number of media acquisition modules. An audio bitstream may be generated by encoding the signals may be encoded by any encoder and transmitted to a cloud present between the FLUS source and the FLUS sink, or the signals may be transmitted directly to the cloud without being encoded and encoded in the cloud. Accordingly, in transmitting the audio bitstream to the FLUS sink, the cloud may directly deliver the audio bitstream, may decode and deliver the audio bitstream, or may receive playback environment information of the FLUS sink or the client and selectively deliver only an audio signals required for the playback environment. When the FLUS sink and the client are separated, the FLUS sink may deliver an audio signal to the client connected to the FLUS sink. As an example corresponding to this case, the FLUS sink and the client may be an SNS server and an SNS user, respectively. When the playback environment information and request information of the user are transmitted to the SNS server, the SNS server may deliver only necessary information to the user with reference to the request information of the user.

FIG. 18B, similar to FIG. 18A, illustrates a case where the media acquisition module and the FLUS source are separated for processing. In the case illustrated in FIG. 18B, the FLUS source directly transmits a captured signal to the cloud without sound information processing. The cloud may perform sound information processing on the received captured sounds (or audio signals) to generate various types of audio signals and directly or selectively deliver the same to the FLUS sink. Operations after FLUS sink may be similar to the process described with reference to FIG. 18A, and thus a detailed description thereof will be omitted.

FIG. 18C illustrates a case where each of the media acquisition modules is used as a FLUS source. That is, the figure illustrates a case where a process of capturing arbitrary sound (voice, music, etc.) with a microphone and performing sound information processing thereon by the FLUS source. When the process is completed in the FLUS source, media information (e.g., video information, text information, etc.) including the audio bitstream may be entirely or selectively transmitted to the cloud, and the transmitted information may be processed in the cloud and delivered to the FLUS sink as described above with reference to FIG. 18A.

FIG. 18D, similar to FIG. 18C, illustrates a case where a capture procedure is performed at the FLUS source. When the processing process of the FLUS source is completed, all signals including the audio bitstream may be directly delivered to the FLUS sink. Accordingly, although not shown in detail in FIG. 18D, the audio bitstream transmitted to the FLUS sink may be various types of audio signals formed through sound information processing, or may be signals captured by a microphone. When the FLUS sink receives captured signals, it may perform sound information processing on the signals to generate various types of audio signals and render the same according to the playback environment. Alternatively, when there is a separate client connected, audio signals suitable for the playback environment of the client may be delivered.

In FIGS. 18A and 18B, that is, in an environment in which the media acquisition module is separated from the FLUS sink, information is delivered to the FLUS source via the cloud through the all processing processes. In the case of FIG. 18D, on the other hand, information (e.g., an audio bitstream) may be directly transmitted from the FLUS source to the FLUS sink.

It will be readily understood by those skilled in the art that the scope of the present disclosure is not limited to the embodiments of FIGS. 18A to 18D and that the FLUS source and FLUS sink may use numerous architectures and processes in performing sound information processing based on the F-interface (or F reference point).

In one embodiment, metadata for network-based 360-degree audio (or metadata about sound information processing) may be defined as follows. The metadata for network-based 360-degree audio, which will be described later, may be carried in a separate signaling table, or may be carried in an SDP parameter or 3GPP FLUS metadata (3GPP flus_metadata). The metadata, which will be described later, may be transmitted/received to/from the FLUS source and the FLUS sink through an F-interface connected therebetween, or may be newly generated in the FLUS source or the FLUS sink. An example of the metadata about the sound information processing is shown in Table 1 below.

TABLE 1

| | | Use | Description |
|---|---|---|---|
| FLUSMediaType | | 1 . . . N | |
| | Audio | M | This is intended to deliver metadata containing |
| | | | information related to audio. Each element |
| | | | included in the Audio may or may not be |
| | | | included in FLUSMediaType, and one or more |
| | | | elements may be selected. When the |
| | | | corresponding media in the media parsed from |
| | | | the FLUS source is included in the FLUS |
| | | | media, the above-described type may be sent to |
| | | | the FLUS sink according to a predetermined |
| | | | sequence, and necessary metadata for each |
| | | | type may be transmitted or received. |
| | @AudioType | M | As AudioType, there may be Channel-based |
| | | | audio (0), Scene-based audio (1), and Object- |
| | | | based audio (2), and a extended version thereof |
| | | | may include audio (3) combining Channel and |
| | | | Object, audio (4) combining Scene and Object, |
| | | | audio (5) combining Scene and Channel, and |
| | | | audio (6) combining Channels, Scene and Object. |
| | | | The numbers in parentheses may be the values of |
| | | | the corresponding metadata. |

| | | |
|---|---|---|
| CaptureInfo | M | As information on the audio capture process, |
| | | multiple audios of the same type may be |
| | | captured, or audios of different types may be |
| | | captured. |
| AudioInfoType | M | Contains related information according to the |
| | | type of the audio signal, for example, |
| | | loudspeaker related information in the case of |
| | | a channel signal, and object attribute |
| | | information in the case of an object signal. The |
| | | corresponding Type contains information |
| | | about all types of signals. |
| SignalInfoType | M | As information about the audio signal, basic |
| | | information identifying the audio signal is |
| | | contained. |
| EnvironmentInfoType | M | Contains information on the captured space or |
| | | the space to be reproduced and information |
| | | about both ears of the user in consideration of |
| | | binaural output |

Data contained in the CaptureInfo representing information about the audio capture process may be given, for example, as shown in Table 2 below.

TABLE 2

| CaptureInfo | | M | As information on the audio capture process, several audio types of the |
|---|---|---|---|
| | | | same type or different types of audio may be captured at the same time. |
| | @NumOfMicArray | M | Mic Array represents an apparatus having multiple microphones installed in |
| | | | one microphone device, and NumOfMicArray represents the total number of |
| | | | MicArrays. |
| | MicArrayID | 1 . . . N | Defines a unique ID of each Mic. array to identify multiple Mic. arrays. |

| | | |
|---|---|---|
| @CapturedSignalType | M | Defines the type of a captured signal. It may be a signal for channel audio |
| | | (0), a signal for scene based audio (1), and a signal for object audio (2). The |
| | | numbers in parentheses may be the values of the corresponding metadata. |
| @NumOfMicPerMicArray | M | Represents the number of microphones mounted on each Mic. array. In |
| | | general, a Mic. array provided with multiple microphones is used |
| | | (NumOfMicPerMicArray = M2) to capture the HOA signal, and one mic. is |
| | | used (NumOfMicPerMicArray = 1) to capture an object or channel signal. |
| MicID | 1 . . . N | Defines a unique ID for identifying each Mic. in consideration of the case |
| | | where multiple mics are used in MicArray. |

| | | |
|---|---|---|
| @MicPosAzimuth | M | Indicates the azimuth information about Mics that constitute the Mic. array. |
| @MicPosElevation | M | Indicates the elevation information about Mics that constitute the Mic. array. |
| @MicPosDistance | M | Indicates the distance information about Mics that constitute the Mic. array. |
| @SamplingRate | M | Indicates the sampling rate of the captured signal. |
| @AudioFormat | M | Indicates the format of the captured signal. The captured signal may be |
| | | defined in .wav or a compressed format such as or .mp3, .aac, and .wma |
| | | immediately after being captured. |
| @Duration | O | Indicates the total recording time. (e.g., xx:yy:zz, min:sec:msec) |
| @NumOfUnitTime | O | Represents the total number obtained by dividing the capture time by a unit |
| | | time in consideration of a case where the mic. position is changed in the |
| | | capture process. |
| @UnitTime | O | Sets the unit time. It is defined in units of msec. |
| UnitTimeIdx | 0 . . . N | Defines an index for every unit time. As the unit time increases, the |
| | | index increases. |

| | | |
|---|---|---|
| @PosAzimuthPerUnitTime | CM | Represents the azimuth information about the mic. location measured every |
| | | unit time. The angle is considered to increase as a positive value when the |
| | | front of the horizontal plane is set to 0° and rotation is performed |
| | | counterclockwise (leftward when viewed from above). The azimuth ranges |
| | | from −180° to 180°. |
| @PosElevationPerUnitTime | CM | Represents the elevation information about the mic. location measured every |
| | | unit time. The elevation is considered to increase as a positive value when |
| | | the front of the horizontal plane is set to 0°, and the position rises vertically. |
| | | The elevation ranges from −90° to 90°. |
| @PosDistancePerUnitTime | CM | Represents the distance information about the mic. location measured every |
| | | unit time. The diameter from the center of the recording environment to the |
| | | microphone is indicated in meters (e.g., 0.5 m). |

| | | |
|---|---|---|
| MicParams | 0 or 1 | The MicParams Type may be named MicParams, and includes |
| | | parameter information defining the characteristics of the mic. |

| | | |
|---|---|---|
| @TransducerPrinciple | M | Determines the type of a transducer. It may be Condenser, Dynamic, |
| | | Ribbon, Carbon, Piezoelectric, Fiber optic, Laser, Liquid, MEMS Mic., or |
| | | the like. |
| @MicType | M | Determines the microphone type. It may be pressure-gradient, pressure type, |
| | | or a combination of both. |
| @DirectRespType | M | Determine the type of a directional microphone. It may be cardioid, |
| | | hypercarioid, supercardioid, subcardioid, or the like. |
| @FreeFieldSensitivity | M | Represents the ratio of the output voltage to the sound pressure level that is |
| | | received sound. For example, it is expressed in a format such as 2.6 mV/Pa. |
| @PoweringType | M | Represents a voltage and current supply method. An example is IEC 61938. |
| @PoweringVoltage | M | Defines the supply voltage. For example, it may be expressed as 48 V. |
| @PoweringCurrent | M | Defines the supply current. For example, it may be expressed as 3 mA. |
| @FreqResponse | M | Represents the frequency band in which sound as close to the original sound |
| | | as possible can be received. When the original sound is received, the slope |
| | | of the frequency response becomes zero (flat). |
| @MinFreqResponse | M | Represents the lowest frequency in the flat frequency band in the entire |
| | | frequency response of the microphone. |
| @MaxFreqResponse | M | Represents the highest frequency in the flat frequency band in the entire |
| | | frequency response of the microphone. |
| @InternalImpedance | M | Represents the internal impedance of the microphone. In general, the |
| | | microphone provides output power according to the internal impedance. For |
| | | example, the impedance is expressed as 50 ohms output. |
| @RatedImpedance | M | Represents the rated impedance of the microphone. It indicates actually |
| | | measured impedance. For example, it is expressed as 50 ohms rated output. |
| @MinloadImpedance | M | Represents the minimum applied impedance. For example, it is expressed as >1k |
| | | ohms load. |
| @DirectionalPattern | M | Represents the directional pattern of the microphone. In general, most |
| | | patterns are polar patterns. In detail, the polar patterns may be divided into |
| | | Omnidirectional, Figure of 8, Subcardioid, Cardioid, Hypercardioid, |
| | | Supercardioid, Shotgun, etc. according to the sensitivity, which varies with |
| | | the direction of sound reception. |
| @DirectivityIndex | M | Represents the directivity index, and is expressed as DI. DI may be |
| | | calculated by the difference in sensitivity between the free field and the |
| | | diffuse field, and it may be considered that as the value increases, the |
| | | directivity in a specific direction becomes stronger. |
| @PercentofTHD | M | Represents the percentage of the total harmonic threshold. This field |
| | | indicates a value measured at the maximum sound pressure level defined in |
| | | the DBofTHD field m, and may be expressed as <5%. |
| @DBofTHD | M | Represents the maximum sound pressure level when the percentage of the |
| | | total harmonic threshold is measured. For example, the maximum sound |
| | | pressure level may be expressed as 138 dB SPL. |
| @OverloadSoundPressure | M | Represents the maximum sound pressure level that the microphone can |
| | | produce without causing distortion. For example, it may be expressed as 138 |
| | | dB SPL, @ 0.5% THD. |
| @InterentNoise | M | Represents the noise inherent in the microphone. In other words, it |
| | | represents self-noise. For example, it may be expressed as 7 dB-A/17.5 dB |
| | | CCIR. |

Next, an example of AudioInfoType representing related information according to the type of the audio signal may be configured as shown in Table 3 below.

TABLE 3

| AudioInfoType | | M | Contains related information according to the type of the audio signal, |
|---|---|---|---|
| | | | for example, loudspeaker related information in the case of a channel |
| | | | signal, and object attribute information in the case of an object signal. |
| | | | The corresponding Type contains information about all types of signals. |
| | @NumOfAudioSignals | M | Represents the total number of signals. The signals may be signals of a |
| | | | channel type, object type, HOA type, and the like. |
| | AudioSignalID | 1 . . . N | Defines a unique ID to identify each signal. |

| | | |
|---|---|---|
| @SignalType | M | Represents the signal type. One of Channel type (0), Object type (1), and |
| | | HOA type (2) is selected, and the attributes used below are also changed |
| | | depending on the selected signal. (The numbers in parentheses may be the |
| | | values of the corresponding metadata.) |

| | | |
|---|---|---|
| @NumOfLoudSpeakers | M | Represents the total number of signals to be output to the loudspeaker. |
| LoudSpeakerID | 1 . . . N | Defines unique IDs of the loudspeakers to identify multiple loudspeakers |
| | | (This is defined when the SignalType is Channel). |

| | | |
|---|---|---|
| @Coordinate System | M | Represents the axis information used to indicate the loudspeaker location |
| | | information. It may have a value of 0 or 1. When the value is 0, it means |
| | | Cartesian coordinates. When the value is 1, it means Spherical coordinates. |
| | | Attributes used below vary according to the set value. |
| @LoudspeakerPosX | CM | Indicates the loudspeaker location information on the X axis. Here, the X- |
| | | axis refers to the direction from front to back, and a positive value is given |
| | | when the loudspeaker is on the front side. |
| @LoudspeakerPosY | CM | Indicates the loudspeaker location information on the Y axis. Here, the Y- |
| | | axis refers to the direction from left to right, and a positive value is given |
| | | when the loudspeaker is on the left side. |
| @LoudspeakerPosZ | CM | Indicates the loudspeaker location information on the Z axis. Here, the Z- |
| | | axis refers to the direction from top to bottom, and a positive value is given |
| | | when the loudspeaker is on the upper side. |
| @LoudspeakerAzimuth | CM | Represents the azimuth information about the loudspeaker location. The |
| | | angle is considered to increase as a positive value when the front of the |
| | | horizontal plane is set to 0° and rotation is performed counterclockwise |
| | | (leftward when viewed from above). |
| @LoudspeakerElevation | CM | Represents the elevation information about the loudspeaker location. The |
| | | elevation is considered to increase as a positive value when the front of the |
| | | horizontal plane is set to 0°, and the location rises vertically |
| @LoudspeaekerDistance | CM | Represents the distance information about the loudspeaker location. The |
| | | diameter from the center to the loudspeaker based on the center value is |
| | | expressed in meters (e.g., 0.5 m). |

| | | |
|---|---|---|
| @FixedPreset | O | Sets loudspeaker locations based on the location information about |
| | | loudspeakers with reference to the predefined loudspeaker layout. The |
| | | location information about loudspeakers basically conforms to the |
| | | loudspeaker layout defined in the standard ISO/IEC 23001-8. Unless ID for |
| | | identifying the loudspeakers is defined separately, the ID of the loudspeakers |
| | | starts from 0 in order as defined in the standard. |

| | | |
|---|---|---|
| @NumOfFixedPresetSubset | OD | Represents the total number of loudspeakers that are not to be used in the |
| | Default: | predefined location information about the loudspeakers. |
| | 0 | |
| SubsetID | 0 . . . N | Defines ID to identify subsets. |

| | | |
|---|---|---|
| @FixedPresetSubsetIndex | CM | Represents a loudspeaker that is not to be used in the predefined location |
| | | information about the loudspeakers. |

| | | |
|---|---|---|
| @NumOfObject | M | Represents the number of audio objects constituting a scene. |
| ObjectID | 0 . . . N | Defines unique ID of objects to distinguish between multiple objects |
| | | (which is defined when SignalType is Object). |

| | | |
|---|---|---|
| @Coordinate System | M | Defines the axis information used to indicate the location information about |
| | | an object. It may have a value of 0 or 1. When the value is 0, it means |
| | | Cartesian coordinates. When the value is 1, it means Spherical coordinates. |
| | | Attributes used below vary according to the set value. |
| @ObjectPosX | CM | Represents object location information on the X axis. Here, the X-axis refers |
| | | to the direction from front to back, and a positive value is given when the |
| | | object is on the front side. |
| @ObjectPosY | CM | Represents object location information on the Y axis. Here, the Y-axis refers |
| | | to the direction from left to right, and a positive value is given when the |
| | | object is on the left side. |
| @ObjectPosZ | CM | Represents object location information on the Z axis. Here, the Z-axis refers |
| | | to the direction from top to bottom, and a positive value is given when the |
| | | object is on the upper side. |
| @ObjectPosAzimuth | CM | Represents the azimuth information about the location of the object. The |
| | | angle is considered to increase as a positive value when the front of the |
| | | horizontal plane is set to 0° and rotation is performed counterclockwise |
| | | (leftward when viewed from above). The azimuth ranges from −180° to |
| | | 180°. |
| @ObjectPosElevation | CM | Represents the elevation information about the location of the object. The |
| | | elevation is considered to increase as a positive value when the front of the |
| | | horizontal plane is set to 0°, and the location rises vertically. The elevation |
| | | ranges from −90° to 90°. |
| @ObjectPosDistance | CM | Represents the distance information about the location of the object. The |
| | | diameter from the center to the object is expressed in meters (e.g., 0.5 m). |
| @ObjectWidthX | CM | Represents the size of the object in the X-axis direction, which is expressed |
| | | in meters (e.g., 0.1 m). |
| @ObjectDepthY | CM | Represents the size of the object in the Y-axis direction, which is expressed |
| | | in meters (e.g., 0.1 m). |
| @ObjectHeightZ | CM | Represents the size of the object in the Z-axis direction, which is expressed |
| | | in meters (e.g., 0.1 m). |
| @ObjectWidth | CM | Represents the size of the object in the horizontal direction, which is |
| | | expressed in degrees (e.g., 45°). |
| @ObjectHeight | CM | Represents the size of the object in the vertical direction, which is expressed |
| | | in degrees (e.g., 20°). |
| @ObjectDepth | CM | Represents the size of the object in the distance direction, which is expressed |
| | | in meters (e.g., 0.2 m). |
| @NumOfDifferentialPos | OD | Represents the total number of pieces of location information about an object |
| | Default: | recorded per unit time in the case of a moving object. Depending on the |
| | 0 | value of @Coordinate System above, the types of attributes used below vary. |
| @Differentialvalue | OD | Defines the unit change amount of a moving object. When no value is set, 0 |
| | Default: | is automatically set. |
| | 0 | |
| DifferentialPosID | 0 . . . N | A new index is defined for each unit change amount of each object. For |
| | | example, assuming that change occurs by 10 with a change amount of 2, |
| | | DifferentialPosIdx = 2, 4, 6, 8, 10 is defined in order. |

| | | |
|---|---|---|
| @DifferentialPosX | CM | Amount of change of the location of the object that changes on the X axis |
| | | every unit time. |
| @DifferentialPosY | CM | Amount of change of the location of the object that changes on the Y-axis |
| | | every unit time. |
| @DifferentialPosZ | CM | Amount of change of the location of the object that changes on the Z-axis |
| | | every unit time. |
| @DifferentialPosAzimuth | CM | Amount of change of the location of the object that changes in terms of |
| | | azimuth every unit time. |
| @DifferentialPosElevation | CM | Amount of change of the location of the object that changes in terms of |
| | | elevation every unit time. |
| @DifferentialPosDistance | CM | Amount of change of the location of the object that changes in terms of |
| | | distance every unit time. |

| | | |
|---|---|---|
| @Diffuse | OD | Indicates the degree of diffusion of the object. When the value is 0, it |
| | Default: | indicates the minimum degree of diffusion, that is, it indicates that the sound |
| | 0 | of the object is coherent. When the value is 1, it indicates that the sound of |
| | | the object is diffuse. |
| @Gain | OD | Indicates the gain value of the object. A linear value (not a value in dB) is |
| | Default: | given by default. |
| | 1.0 | |
| @ScreenRelativeFlag | OD | Determines whether the played object is linked to the screen. When the |
| | Default: | ScreenRef flag is 1, it means that the location of the object is linked with the |
| | 0 | screen size. When the flag is 0, it means that the location of the object is not |
| | | linked with the screen size. When the ScreenRef flag is set to 1 and screen |
| | | information about the playback environment is not given, the screen |
| | | information conforms to the standard of the default screen defined in |
| | | Recommendation ITU-R BT.1845. The standard of the default screen in the |
| | | Spherical coordinate system is given as follows. |
| | | <Default screen size> |
| | | : Azimuth of left bottom corner of screen: 29.0 |
| | | : Elevation of the left bottom corner of screen −17.5 |
| | | : Aspect ratio: 1.78 (16:9) |
| | | : Width of the screen 58 (as defined by image system 3840 × 2160) |
| | | [Reference] Recommendation ITU-R BT.1845 - Guidelines on metrics to |
| | | be used when tailoring television programmes to broadcasting applications at |
| | | various image quality levels, display sizes and aspect ratios. |
| @Importance | OD | When one audio scene contains multiple objects, the priority of each object |
| | Default: | is determined. The importance is scaled from 0 to 10, and 10 is used for the |
| | 10 | highest object and 0 is used for the lowest object. |

| | | |
|---|---|---|
| @Order | CM | Represents the order of the HOA component (e.g., 0, 1, , 2, . . . ). This is |
| | | defined only when the SignalType attribute is HOA. |
| @Degree | CM | Represents the degree of the HOA component (e.g., 0, 1, 2, . . . ). This is |
| | | defined only when the SignalType attribute is HOA. |
| @Normalization | CM | Represents a normalization scheme of the HOA component. Types of |
| | | normalization schemes include N3D, SN3D, and FuMa. This is defined only |
| | | when the SignalType attribute is HOA. |
| @NfcRefDist | CM | This parameter indicates the distance information (expressed in meters) that |
| | | is referred to when scene-based audio contents are produced. This |
| | | information may be used for audio rendering for Near Field Compensation |
| | | (NFC). This is defined only when the SignalType attribute is HOA. |
| @ScreenRelativeFlag | CM | When the screen flag is 1, it means that scene-based contents are linked. |
| | | This means that a renderer for specially adjusting scene-based contents is |
| | | used in consideration of the production screen size (the size of the screen |
| | | used when the scene-based contents were produced) and the playback screen |
| | | size. This is defined only when the SignalType attribute is HOA. |

Next, an example of AudioInfoType representing basic information for identifying an audio signal may be configured as characteristics information about the audio signal or information about the audio signal, as shown in Table 4 below.

TABLE 4

| SignalInfoType | | M | Represents information about the audio signal. It includes basic |
|---|---|---|---|
| | | | information for identifying the audio signal. |
| | @NumOfSignals | M | Represents the total number of signals. It may be the sum of two types of |
| | | | signals when two or more types are combined. |
| | SignalID | 1 . . . N | Defines unique IDs of signals to distinguish between multiple signals. |

| | | |
|---|---|---|
| @SignalType | M | Identifies whether the audio signal is of the channel type, object type, or |
| | | HOA type. |
| @FormatType | M | Defines the format of each audio signal. It may be a compressed or |
| | | uncompressed format such as .wav, .mp3, .aac, or .wma. |
| @SamplingRate | O | Represents the sampling rate of the audio signal. In general, there is already |
| | | sampling rate information in the header of the uncompressed format .wav and |
| | | the compressed format .mp3 or .aac, and accordingly the information does |
| | | not need to be transmitted depending on the situation. |
| @BitSize | O | Represents the bit size of the audio signal. It may be 16 bits, 24 bits, 32 bits, |
| | | or the like. In general, there is bit size information in the header of the |
| | | uncompressed format .wav and the compressed format .mp3 or .aac, and |
| | | accordingly the information does not need to be transmitted depending on the |
| | | situation. |
| @StartTime | OD | Represents the bit size of the audio signal. In general, there is already |
| | Default: | sampling rate information in the header of the uncompressed format .wav and |
| | 00:00:00 | the compressed format .mp3 or .aac, and accordingly the information does |
| | | not need to be transmitted depending on the situation. It indicates the start |
| | | time of the audio signal. This is used to ensure sync with other audio signals. |
| | | If StartTime differs between different audio signals, the signals are |
| | | reproduced at different times. However, if different audio signals have the |
| | | same StartTime, both signals should be reproduced exactly at the same time. |
| @Duration | O | Represents the total playback time (e.g., xx:yy:zz, min:sec:msec). |

Next, sound environment information including information about a space for at least one audio signal acquired through the media acquisition module and information about both ears of at least one user of the audio data reception apparatus may be presented by, for example, EnvironmentInfoType. An example of EnvironmentInfoType may be configured as shown in Table 5 below.

TABLE 5

| EnvironmentInfoType | | M | Contains information on the captured space or the space for |
|---|---|---|---|
| | | | reproduction and binaural information about the user in consideration |
| | | | of binaural output. |
| | @NumOfPersonalInfo | O | Represents the total number of users having binaural information. |
| | PersonalID | 0 . . . N | Defines a unique ID of a user having binaural information to distinguish |
| | | | information about multiple users. |

| | | |
|---|---|---|
| @Head width | M | Represents the diameter of the head. It is expressed in meters. |
| @Cavum concha height | M | Represents the height of the cavum concha, which is a part of the ear. It is |
| | | expressed in meters. |
| @Cymba concha height | M | Represents the height of the cymba concha, which is a part of the ear. It is |
| | | expressed in meters. |
| @Cavum concha width | M | Represents the width of the cavum concha, which is a part of the ear. It is |
| | | expressed in meters. |
| @Fossa height | M | Represents the height of the fossa, which is a part of the ear. It is expressed |
| | | in meters. |
| @Pinna height | M | Represents the height of the pinna, which is a part of the ear. It is expressed |
| | | in meters. |
| @Pinna width | M | Represents the width of the pinna, which is a part of the ear. It is expressed |
| | | in meters. |
| @Intertragal incisures width | M | Represents the width of the intertragal incisures, which is a part of the ear. It |
| | | is expressed in meters. |
| @Cavym concha | M | Represents the length of the cavym concha, which is a part of the ear. It is |
| | | expressed in meters. |
| @Pinna rotation angle | M | Represents the rotation angle of the pinna, which is a part of the ear. It is |
| | | expressed in degrees. |
| @Pinna flare angle | M | Represents the flare angle of the pinna, which is a part of the ear. It is |
| | | expressed in degrees. |

| | | |
|---|---|---|
| @NumOfResponses | M | Represents the total number of responses captured (or modeled) in an |
| | | arbitrary environment. |
| ResponseID | 1 . . . N | Defines a unique ID for every response to identify multiple responses. |

| | | |
|---|---|---|
| @RespAzimuth | M | Represents the azimuth information about the captured response location. |
| | | The angle is considered to increase as a positive value when the front of the |
| | | horizontal plane is set to 0° and rotation is performed counterclockwise |
| | | (leftward when viewed from above). The azimuth ranges from −180° to 180°. |
| @RespElevation | M | Represents the elevation information about the captured response location. |
| | | The elevation is considered to increase as a positive value when the front of |
| | | the horizontal plane is set to 0°, and the location rises vertically. The |
| | | elevation ranges from −90° to 90°. |
| @RespDistance | M | Represents the distance information about the captured response location. |
| | | The diameter from the center to the object is expressed in meters (e.g., 0.5 m). |
| @IsBRIR | OD | Defines whether to use BRIR as a response. If the attribute is not defined, it |
| | Default: | is assumed that the BRIR response is basically used. |
| | true | |
| BRIRInfo | CM | Defines the binaural room impulse response (BRIR). The BRIR may be |
| | | captured and used directly as a filter, or may be used after modeling. |
| | | When it is used as a filter, filter information is transmitted through a |
| | | separate stream. |
| RIRInfo | CM | Defines the room impulse response (RIR). The RIR may be captured |
| | | and used directly as a filter, or may be used after modeling. When it is |
| | | used as a filter, filter information is transmitted through a separate |
| | | stream. |

BRIRInfo included in EnvironmentInfoType may indicate characteristics information about the binaural room impulse response (BRIR). An example of BRIRInfo may be configured as shown in Table 6 below.

TABLE 6

| BRIRInfo | | CM | Defines the binaural room impulse response (BRIR). The BRIR may be |
|---|---|---|---|
| | | | captured and used directly as a filter, or may be used after modeling. |
| | | | When it is used as a filter, filter information is transmitted through a |
| | | | separate stream. |
| | @ResponseType | M | Defines the response type. For a response, the coefficient value of the |
| | | | recorded IR may be used (0), or the response may be modeled using physical |
| | | | space parameters defined below (1), or may be modeled using perceptual |
| | | | parameters (2). The numbers in parentheses may represent metadata values |
| | | | for corresponding processes. |
| | FilterInfo | CM | Defines information about a filter type response. Only basic information |
| | | | about the filter is described below, and filter information is directly |
| | | | transmitted in a separate stream. |

| | | |
|---|---|---|
| @SamplingRate | OD | Represents the sampling rate of the response. It may be 48 kHz, 44.1 kHz, |
| | Default: | 32 kHz, or the like. |
| | 48 kHz | |
| @BitSize | OD | Represents the bit size of the captured response sample. It may be 16 bits, 24 |
| | Default: | bits, or the like. |
| | 24 bit | |
| @Length | O | Represents the length of the captured response. The length is calculated in a |
| | | sample-by-sample basis. |

| | | |
|---|---|---|
| PhysicalModelingInfo | CM | Defines parameters used in performing modeling based on the |
| | | characteristics information about the space. |

| | | |
|---|---|---|
| DirectiveSound | M | Contains parameter information that defines the characteristics of a direct |
| | | component of the response. When the ResponseType attribute is defined to |
| | | perform modeling, the element is unconditionally defined. |
| AcousticSceneType | M | Contains characteristics information about the space in which the response is |
| | | captured or modeled. This element is used only when the ResponseType |
| | | attribute is defined to model physical space. |
| AcousticMaterialType | M | Contains characteristics information about the medium constituting the space |
| | | in which the response is captured or modeled. This element is used only |
| | | when the ResponseType attribute is defined to model physical space. |

| | | |
|---|---|---|
| PerceputalModelingInfo | CM | Defines parameters used in performing modeling based on perceptual |
| | | feature information in an arbitrary space. |

| | | |
|---|---|---|
| DirectiveSound | M | Contains parameter information that defines the characteristics corresponding |
| | | to the direct component in the response. When ResponseType attribute is |
| | | defined to perform modeling, the element is unconditionally defined. |
| PerceptualParams | M | Contains information describing features that may be perceived in the |
| | | captured space or the space for reproduction. The response may be modeled |
| | | based on the information. This element is used only when the ResponseType |
| | | attribute is defined to perform perceptual modeling. |

Next, RIRInfo included in EnvironmentInfoType may indicate characteristics information about a room impulse response (RIR). An example of RIRInfo may be configured as shown in Table 7 below.

TABLE 7

| RIRInfo | | CM | Defines the room impulse response (RIR). The RIR may be captured |
|---|---|---|---|
| | | | and used directly as a filter, or may be used after modeling. When it is |
| | | | used as a filter, filter information is transmitted through a separate |
| | | | stream. |
| | @ResponseType | M | Defines the response type. For a response, the coefficient value of the |
| | | | recorded IR may be used (0), or the response may be modeled using physical |
| | | | space parameters defined below (1), or may be modeled using perceptual |
| | | | parameters (2). The numbers in parentheses may represent metadata values |
| | | | for corresponding processes. |
| | FilterInfo | CM | Defines information about a filter type response. Only basic information |
| | | | about the filter is described below, and filter information is directly |
| | | | transmitted in a separate stream. |

| | | |
|---|---|---|
| @SamplingRate | OD | Represents the sampling rate of the response. It may be 48 kHz, 44.1 kHz, |
| | Default: | 32 kHz, or the like. |
| | 48 kHz | |
| @BitSize | OD | Represents the bit size of the captured response sample. It may be 16 bits, 24 |
| | Default: | bits, or the like. |
| | 24 bit | |
| @Length | O | Represents the length of the captured response. The length is calculated in a |
| | | sample-by-sample basis. |

| | | |
|---|---|---|
| PhysicalModelingInfo | CM | Defines parameters used in performing modeling based on the |
| | | characteristics information about the space. |

| | | |
|---|---|---|
| DirectiveSound | M | Contains parameter information that defines the characteristics of a direct |
| | | component of the response. When the ResponseType attribute is defined to |
| | | perform modeling, the element is unconditionally defined. |
| AcousticSceneType | M | Contains characteristics information about the space in which the response is |
| | | captured or modeled. This element is used only when the ResponseType |
| | | attribute is defined to model physical space. |
| AcousticMaterialType | M | Contains characteristics information about the medium constituting the space |
| | | in which the response is captured or modeled. This element is used only |
| | | when the ResponseType attribute is defined to model physical space. |

| | | |
|---|---|---|
| PerceputalModelingInfo | CM | Defines parameters used in performing modeling based on perceptual |
| | | feature information in an arbitrary space. |

| | | |
|---|---|---|
| DirectiveSound | M | Contains parameter information that defines the characteristics of a direct |
| | | component of the response. When the ResponseType attribute is defined to |
| | | perform modeling, the element is unconditionally defined. |
| PerceptualParams | M | Contains information describing features that may be perceived in the |
| | | captured space or the space for reproduction. The response may be modeled |
| | | based on the information. This element is used only when the ResponseType |
| | | attribute is defined to perform perceptual modeling. |

DirectiveSound included in BRIRInfo or RIRInfo may contain parameter information defining characteristics of the direct component of the response. An example of information contained in DirectiveSound may be configured as shown in Table 8 below.

TABLE 8

| DirectiveSound | | M | Contains parameter information that defines the characteristics of a |
|---|---|---|---|
| | | | direct component of the response. When the ResponseType attribute is |
| | | | defined to perform modeling, the element is unconditionally defined. |
| | @NumOfAngles | M | Represents the total number of angles at which a frequency dependent gain is |
| | | | defined. |
| | AngleID | 1 . . . N | Defines ID to identify each angle. |

| | | |
|---|---|---|
| @Angles | M | Represents direction information about a sound source located in a space and |
| | | information about an angle between users, and is defined in radians. |
| @NumOfFreqs | M | Represents the total number of frequencies considered in defining a gain at an |
| | | arbitrary angle. Therefore, when there are M angles defined and N |
| | | frequencies are considered at an arbitrary angle, M × N gains are defined in |
| | | total. The gain values are defined in DirectivityCoeff of the Directivity |
| | | attribute. |
| FreqID | 1 . . . N | Defines ID to identify each frequency. |

| | | |
|---|---|---|
| @Frequency | CM | Defines the frequency at which the directivity gain is effective. |
| @DirectivityOrder | M | Defines directivity order. If multiple frequencies are not separately defined |
| | | above (i.e., 1 frequency), DirectivityOrder is set to 1. The total number of |
| | | directivity coefficients is defined only for M angles. However, if multiple |
| | | values are defined in the Frequency field (i.e. => 2), when DirecivityOrder is |
| | | P, 2*P + 1 coefficients (P-th order IIR filter) are defined for each angle and |
| | | frequency. |
| OrderIdx | 1 . . . N | Defines the index of the order. |

| | | |
|---|---|---|
| @DirecitvityCoeff | M | Defines the value of the directivity coefficient. |

| | | |
|---|---|---|
| @DirectionAzimuth | M | Represents the azimuth angle information about the source direction. The |
| | | angle is considered to increase as a positive value when the front of the |
| | | horizontal plane is set to 0° and rotation is performed counterclockwise |
| | | (leftward when viewed from above). The azimuth ranges from -180° to 180°. |
| @DirectionElevation | M | Represents the elevation information about the source direction. The |
| | | elevation is considered to increase as a positive value when the front of the |
| | | horizontal plane is set to 0°, and the location rises vertically. The elevation |
| | | ranges from -90° to 90°. |
| @DirectionDistance | M | Represents the distance information about the source direction. The diameter |
| | | from the center to the object is expressed in meters (e.g., 0.5 m). |
| @Intensity | M | Indicates the overall gain of the source. |
| @SpeedOfSound | OD | Defines the speed of sound and is used to control the delay or Doppler effect |
| | Default: | that varies with the distance between the source and the user. |
| | 340 m/s | |
| @UseAirabs | OD | Specifies whether to apply, to the sound source, air resistance according to |
| | Default: | distance. |
| | false | |

Next, PerceptualParamsType may contain information describing features perceivable in a captured space or a space in which an audio signal is to be reproduced. An example of the information contained in PerceptualParamsType may be configured as shown in Table 9 below.

TABLE 9

| PerceptualParamsType | | M | Contains information describing features that may be perceived in the |
|---|---|---|---|
| | | | captured space or the space for playback. The response may be modeled |
| | | | based on the information. This element is used only when the |
| | | | ResponseType attribute is defined to perform perceptual modeling. |
| | @NumOfTimeDiv | M | Total number of parts into which a response is divided on the time axis. |
| | | | Usually, a response is divided into 4 parts: the direct part, the early reflection |
| | | | part, the diffuse part, and the late reverberation part. |
| | TimeDivIdx | 1 . . . N | Defines the index of TimeDiv. |

| | | |
|---|---|---|
| @DivTime | M | Represents the time taken to reach a divided response after the start time of a |
| | | direct response. It is expressed in ms. |
| @NumOfFreqDiv | M | Total number of parts into which a response is divided in terms of frequency. |
| | | Usually, a response is divided into 3 parts: low freq., mid freq., and high freq. |
| FreqDivIdx | M | Defines the index of FreqDiv. |

| | | |
|---|---|---|
| @DivFreq | M | Represents a divided frequency value. For example, if a response with a |
| | | bandwidth of 20 kHz is divided into two bands based on 10 kHz, a total of |
| | | two ‘NumOfFreqDiv's are declared, and values of 10 and 20 are defined for |
| | | @DivFreq. |
| @SourcePresence | M | Represents the energy of the early part of the room response, and is defined as |
| | | a value in the range of 0 to 1. This describes the feature of perceiving a sound |
| | | source located at a specific distance from the user. |
| @SourceWarmth | M | Represents a characteristic emphasizing the energy of the low frequency band |
| | | of the early part of the room response, and is defined as a value in the range of |
| | | 0.1 to 10. This implies that as the value increases, the band is further |
| | | emphasized. |
| @SourceBrilliance | M | Represents a characteristic emphasizing the energy of the high frequency band |
| | | of the early part of the room response, and is defined as a value in the range of |
| | | 0.1 to 10. This implies that as the value increases, the band is further |
| | | emphasized. |
| @RoomPresence | M | Represents energy information about the diffuse early reflection part and the |
| | | late reverberation part, and is defined as a value in the range of 0 to 1. |
| @RunningReverberance | M | Represents the early decay time and is defined as a value in the range of 0 to |
| | | 1. |
| @Envelopment | M | Represents the energy ratio of direct sound and early reflection, and is defined |
| | | as a value in the range of 0 to 1. A greater value means larger energy in the |
| | | early reflection part. |
| @LateReverberance | M | A concept opposite to RunningReverberance. This represents the decay time |
| | | of the late reverberation part, and is defined as a value in the range of 0.1 to |
| | | 1000. RunningReverberance field represents the characteristic of reflection |
| | | that is perceived when an arbitrary sound is continuously reproduced, and |
| | | LateReverberance represents the characteristic of reverberation that is |
| | | perceived when the arbitrary sound is stopped. |
| @Heavyness | M | Represents a characteristic emphasizing the decay time of the low frequency |
| | | band of the room response, and is defined as a value in the range of 0.1 to 10. |
| @Liveness | M | Represents a characteristic of emphasizing the decay time of the high |
| | | frequency band of the room response, and is defined as a value in the range of |
| | | 0.1 to 1. |
| @NumOfDirecitvityFreqs | 0 | Defines the total number of frequencies at which the Omnidirectivity gain is |
| | | defined. |

| | | |
|---|---|---|
| DirecitvityFreqIdx | 0 . . . N | Assigns an index to each frequency at which Omnidirectivity gain is |
| | | defined. |

| | | |
|---|---|---|
| @OmniDirectivityFreq | OD | Defines a frequency at which the Omnidirectivity gain is defined. If no value |
| | Default: | is defined in the NumOfDirecitivityFreqs attribute, the frequency is set to 1 |
| | 1 kHz | kHz by default. |
| @OmniDirectivityGain | O | Defines the value of the OmniDirectivity gain. Since this information is |
| | | defined only for the frequency defined in the OmniDirectFreq field, the value |
| | | is defined in connection with the OmniDirectFreq field. |

| | | |
|---|---|---|
| @NurnOfDirectFilterGains | M | Defines the total number of OmniDirectFilter gains. This information is |
| | | linked with OmniDirectiveFreq to define a value. For example, when |
| | | NumOfFreq is set to 6, OmniDirectFreq and OmniDirectGain may be set to [5 |
| | | 250 500 1000 2000 4000] and [1 0.9 0.85 0.7 0.6 0.55], respectively. This |
| | | means that the gain is 1 at 5 Hz, 0.9 at 250 Hz, and 0.85 at 500 Hz. |
| DirectFilterGainsIdx | 0 . . . N | Assigns an index to each OmniDirectFilter gain. |

| | | |
|---|---|---|
| @DirectFilterGain | O | Defines the filter gain of DirectFilterGains. |

| | | |
|---|---|---|
| @NumOfInputFilterGains | M | Defines the value of a filter gain applied only to the direct part. Since this |
| | | information is applied only to the direct part of the room response, in |
| | | consideration of the occlusion effect caused between that the direct part sound |
| | | and a user by an object. The frequency band of the room response may be |
| | | divided into three bands by the LowFreq field and HighFreq field below, and |
| | | the filter gain is applied to each frequency band. |
| InputFilterGainsIdx | 0 . . . N | Assigns an index to each InputFilter gain. |

| | | |
|---|---|---|
| @InputFilterGain | O | Defines the filter gain of InputFilterGains. |

| | | |
|---|---|---|
| @RefDistance | O | Defines the value of a filter gain applied to the sound source and the entire |
| | | room response. This may be regarded as a filter considering even the effect of |
| | | transmission of sound from another space through the wall. |
| @ModalDensity | O | Defined as the number of modes per Hz. This information is useful in causing |
| | | reverberation with an IIR-based reverberation algorithm. |

Next, AcousticSceneType may contain characteristics information about a space in which a response is captured or modeled. An example of the information contained in AcousticSceneType may be configured as shown in Table 10 below.

TABLE 10

| AcousticSceneType | | M | Contains characteristics information about the space in which the |
|---|---|---|---|
| | | | response is captured or modeled. This element is used only when the |
| | | | ResponseType attribute is defined to model physical space. |
| | @CenterPosX | M | Indicates location information about the space on the X axis. Here, the X-axis |
| | | | refers to the direction from front to back, and a positive value is given when |
| | | | the location is on the front side. |
| | @CenterPosY | M | Indicates location information about the space on the Y axis. Here, the Y-axis |
| | | | refers to the direction from left to right, and a positive value is given when the |
| | | | location is on the left side. |
| | @CenterPosZ | M | Indicates location information about the space on the Z axis. Here, the Z-axis |
| | | | refers to the direction from top to bottom, and a positive value is given when |
| | | | the location is on the upper side. |
| | @SizeWidth | M | Represents width information in the space size information, and is expressed |
| | | | in meters (e.g., 5 m). |
| | @SizeLength | M | Represents length information in the space size information, and is expressed |
| | | | in meters (e.g., 5 m). |
| | @SizeHeight | M | Represents height information in the space size information, and is expressed |
| | | | in meters (e.g., 5 m). |
| | @NumOfReverbFreq | O | Represents the total number of frequencies corresponding to the reverberation |
| | | | time defined in the ReverbTime attribute. |
| | ReverbFreqIdx | 1 . . . N | Defines an index for a frequency at which Reverb. is defined. |

| | | |
|---|---|---|
| @ReverbTime | M | Represents the reverberation time of the space. The value is defined in |
| | | seconds. This information is defined only for a frequency defined in the |
| | | ReverbFreq attribute, and accordingly, this attribute is set in connection with |
| | | the ReverbFreq attribute. If only one ReverbTime is defined, the |
| | | corresponding value indicates the reverberation time corresponding to the |
| | | frequency of 1 kHz. |
| @ReverbFreq | OD | Represents a frequency corresponding to the reverberation time defined in the |
| | Default: | ReverbTime attribute. This field is set in connection with the ReverbTime |
| | 1 kHz | attribute. For example, when ReverbFreq is defined in two b places [0 |
| | | 16000], two ReverbTimes are set as [2.0 0.5]. This means that the |
| | | reverberation time is 2.0 s at the frequency of 0 Hz. and 0.5 s at the frequency |
| | | of 16 kHz. |

| | | |
|---|---|---|
| @RevberbLevel | M | Represents the first output level of the reverberator (the magnitude of the first |
| | | sound of the reverberation part in the room response) in proportion to the |
| | | direct sound. |
| @ReverbDelay | M | Represents the time delay between the start times of the direct sound and the |
| | | reverberation, and is defined in msec. |

Next, AcousticMaterialType may indicate characteristics information about a medium constituting a space in which a response is captured or modeled. An example of information contained in AcousticMaterialType may be configured as shown in Table 11 below.

TABLE 11

| AcousticMaterialType | | M | Contains characteristics information about the medium constituting the |
|---|---|---|---|
| | | | space in which the response is captured or modeled. This element is used |
| | | | only when the ResponseType attribute is defined to model physical space. |
| | @NumOfFaces | M | Represents the total number of media (or walls) that constitute the space. For |
| | | | example, for a cubic space, NumOfFaces is set to 6. |
| | FaceID | 1 . . . N | Defines an ID for each face. |

| | | |
|---|---|---|
| @FacePosX | M | Indicates the location information about the medium constituting the space on |
| | | the X axis. Here, the X-axis refers to the direction from front to back, and a |
| | | positive value is given when the object is on the front side. |
| @FacePosY | M | Indicates the location information about the medium constituting the space on |
| | | the Y axis. Here, the Y-axis refers to the direction from left to right, and a |
| | | positive value is given when the location is on the left side. |
| @FacePosZ | M | Indicates the location information about the medium constituting the space on |
| | | the Z axis. Here, the Z-axis refers to the direction from top to bottom, and a |
| | | positive value is given when the location is on the upper side. |
| @NumOfRefFreqs | O | Represents the total number of frequencies corresponding to the reflection |
| | | coefficient information defined in the Reffunc attribute. |
| RefFreqsIdx | 0 . . . N | Assigns an index to each frequency at which the reflection coefficient is |
| | | defined. |

| | | |
|---|---|---|
| @RefFunc | M | Represents the reflection coefficient for an arbitrary material (or wall). It may |
| | | have a value in the range of 0 to 1. When the value is 0, the material absorbs |
| | | the entire sound. When the value is 1, the material reflects the entire sound. |
| | | In general, the reflection coefficient information is defined for the frequency |
| | | defined in the RefFreuqency attribute, and accordingly the corresponding |
| | | attribute is set in connection with the RefFrequency attribute. |
| @RefFrequency | O | Defines a frequency corresponding to the value defined in the Reffunc |
| | | attribute. Accordingly, when it is assumed that RefFrequency is defined in |
| | | [250 1000 2000 4000], Reffunc defines 4 values of [0.75 0.9 0.9 0.2] in total. |

| | | |
|---|---|---|
| @NumOfTransFreqs | O | Represents the total number of frequencies corresponding to the transmission |
| | | coefficient information defined in the Transfunc attribute. |
| TransFreqsIdx | 0 . . . N | Assigns an index to each frequency at which the transmission coefficient is |
| | | defined. |

| | | |
|---|---|---|
| @TransFunc | M | Represents the property of transmission through a material (or wall). It may |
| | | have a value in the range of 0 to 1. When the value is 0, the material blocks |
| | | the entire sound. When the value is 1, the material allows the entire sound to |
| | | pass therethrogh. In general, the transmission coefficient information is |
| | | defined for the frequency defined in the TransFrequency attribute, and |
| | | accordingly the corresponding attribute is set in connection with the |
| | | TransFrequency attribute. |
| @TransFrequency | O | Defines a frequency corresponding to the value defined in the Transfunc |
| | | attribute. |

The metadata about sound information processing disclosed in Tables 1 to 11 may be expressed based on XML schema format, JSON format, file format, or the like.

In an embodiment, the above-described metadata about sound information processing may be applied as metadata for configuration of a 3GPP FLUS. In the case of IMS-based signaling, SIP signaling may be performed in negotiation for FLUS session creation. After the FLUS session is established, the above-described metadata may be transmitted during configuration.

An exemplary case where the FLUS source supports an audio stream is shown in Tables 12 and 13 below. The negotiation of SIP signaling may consist of SDP offer and SDP answer. The SDP offer may serve to transmit, to the reception terminal, specification information allowing the transmission terminal to control media, and the SDP answer may serve to transmit, to the transmission terminal, specification information allowing the reception terminal to control media.

Accordingly, when the exchanged information matches set content, the negotiation may be terminated immediately, determining that the content transmitted from the transmission terminal can be played back on the reception terminal without any problem. However, when the exchanged information does not match the set content, a second negotiation may be started, determining that there is a risk of causing a problem in playing back the media. As in the first negotiation, through the second negotiation, changed information may be exchanged, it may be checked whether the exchanged information match the content set by each terminal. When the information does not match the set content, a new negotiation may be performed. Such negotiation may be performed for all content in exchanged messages, such as bandwidth, protocol, and codec. For simplicity, only the case of 3gpp-FLUS-system will be discussed below.

TABLE 12

| SDP offer | SDP Answer |
|---|---|
| v=0 | v=0 |
| o=user 960 775960 IN IP4 192.168.1.55 | o=user 960 775960 IN IP4 192.168.1.55 |
| s= FLUS | s=FLUS |
| c=IN IP4 192.168.1.55 | c=IN IP4 192.168.1.55 |
| t=0 0 | t=0 0 |
| a=3gpp-FLUS-system:<urn> | a=3gpp-FLUS-system:<urn> |
| m= Audio | m=Audio |
| m=audio 60002 RTP/AVP 127 | m=audio 60002 RTP/AVP 127 |
| b=AS:38 | b=AS38 |
| a=rtpmap:127 EVS/16000 | a=rtpmap:127 EVS/16000 |
| a=ftmp:127 br=5.0-13.2;bw=nb;ch-aw- | a=fmtp:127 br=5.0-13.2;bw=nb;ch-aw- |
| recv=2 | recv=2 |
| a=3gpp-FLUS-system:AudioInfo | a=3gpp-FLUS-system:AudioInfo |
| SignalType 0 | SignalType 0 |
| a=3gpp-FLUS-system:AudioInfo | a=3gpp-FLUS-system:SignalInfo |
| SignalType 1 | a=recvonly |
| a=3gpp-FLUS-system:SignalInfo | a=ptime:20 |
| a=3gpp-FLUS-system:EnvironmentInfo | a=maxptime:240 |
| a=sendonly | |
| a=ptime:20 | |
| a=maxptime:240 | |

Here, the SDP offer represents a session initiation message for an offer to transmit 3gpp-FLUS-system based audio content. Referring to the message of the SDP offer, the offer supports audio as a FLUS source, the version is 0 (v=0), the session-id of the origin is 960 775960, the network type is IN, and the address type is connected based on IP4, and the IP address is 192.168.1.55. Timing value is 0 0 (t=0 0), which corresponds to a fixed session. Next, the media is audio, the port is 60002, the transport protocol is RTP/AVP, and the media format is declared as 127. The offer also suggests that the bandwidth is 38 kbits/s, the dynamic payload type is 127, encoding is EVS, and transmission at the bit-rate of 16 kbps. The values specified in the above-described port number, transport protocol, media format, and the like may be replaced with different values depending on the operation point. A 3gpp-FLUS-system related message shown below indicates metadata related information proposed in an embodiment of the present disclosure in relation to audio signals. That is, it may mean supporting metadata information indicated in the message. a=3gpp-FLUS-system:AudioInfo SignalType 0 may indicate a channel type audio signal, and SignalType 1 may indicate an object type audio signal. Accordingly, the offer message indicates that a channel type signal and an object type audio signal can be transmitted. Separately, a=ptime and a=maxptime are unit frame information for processing an audio signal. a=ptime:20 may indicate that a frame length of 20 ms per packet is required, and a=maxptime: 240 may indicate that the maximum frame length that can be handled at a time per packet is 240 ms. Accordingly, from the perspective of the reception terminal, only 20 ms is basically required as a frame length per packet, but a maximum of 12 frames (12*20=240) may be carried in one packet depending on the situation.

Referring to the message of the SDP answer corresponding to the SDP offer, the transport protocol information and codec-related information may coincide with those of the SDP offer. However, it may be seen from the message of 3gpp-FLUS-system compared to the message of SDP offer that the SDP answer supports only channel type for the audio type and does not support EnvironmentInfo. That is, since the messages of the offer and answer are different from each other, the offer and answer need to send and receive a second message. Table 13 below shows an example of the second message exchanged between the offer and the answer.

TABLE 13

| 2^{nd} SDP offer | 2^{nd} SDP answer |
|---|---|
| v=0 | v=0 |
| o=user 960 775960 IN IP4 192.168.1.55 | o=user 960 775960 IN IP4 192.168.1.55 |
| s= FLUS | s=FLUS |
| c=IN IP4 192.168.1.55 | c=IN IP4 192.168.1.55 |
| t=0 0 | t=0 0 |
| a=3gpp-FLUS-system:<urn> | a=3gpp-FLUS-system:<urn> |
| m= Audio | m=Audio |
| m=audio 60002 RTP/AVP 127 | m=audio 60002 RTP/AVP 127 |
| b=AS:38 | b=AS38 |
| a=rtpmap:127 EVS/16000 | a=rtpmap:127 EVS/16000 |
| a=ftmp:127 br=5.0-13.2;bw=nb;ch-aw-recv=2 | a=fmtp:127 br=5.0-13.2;bw=nb-aw-recv=2 |
| a=3gpp-FLUS-system:AudioInfo SignalType 0 | a=3gpp-FLUS-system:AudioInfo SignalType 0 |
| a=3gpp-FLUS-system:SignalInfo | a=3gpp-FLUS-system:SignalInfo |
| a=sendonly | a=recvonly |
| a=ptime:20 | a= ptime:20 |
| a=maxptime:240 | a= maxptime:240 |

The second message according to Table 13 may be substantially similar to the first message according to Table 12. Only the parts that are different from the first message need to be adjusted. A message related to the port, protocol, and codec is identical to that of the first message. The SDP answer does not support EnvironmentInfo in 3gpp-FLUS-system. Accordingly, the corresponding content is omitted in the 2nd SDP offer, and an indication that only channel type signals are supported is contained in the offer. The response of the answer to the offer is shown in the 2nd SDP answer. Since the 2nd SDP answer shows that the media characteristics supported by the offer are that same as those supported by the answer, the negotiation may be terminated through the second message, and then the media, that is, the audio content may be exchanged between the offer and the answer.

Tables 14 and 15 below shows a negotiation process for information related to EnvironmentInfo among the details contained in the message. In Tables 14 and 15, for simplicity, details of the message, such as port and protocol, are set identically, and the newly proposed negotiation process for the 3gpp-FLUS-system is specified. In the message of the SDP offer, a=3gpp-FLUS-system:EnvironmentInfo ResponseType 0 and a=3gpp-FLUS-system:EnvironmentInfo ResponseType 1 indicate that a captured filter (or FIR filter) and a filter modeled on a physical basis can be used as response types in performing binaural rendering on the audio signal. However, the SDP answer corresponding thereto indicates that only the captured filter is used (a=3gpp-FLUS-system:EnvironmentInfo ResponseType 0). Accordingly, a second negotiation needs to be conducted. Referring to Table 15, it can be seen that the EnvironmentInfo related message of the 2nd SDP offer has been modified and is thus the same as that in the 2nd SDP answer.

TABLE 14

| SDP offer | SDP Answer |
|---|---|
| v=0 | v=0 |
| o=user 960 775960 IN IP4 192.168.1.55 | o=user 960 775960 IN IP4 192.168.1.55 |
| s= FLUS | s=FLUS |
| c=IN IP4 192.168.1.55 | c=IN IP4 192.168.1.55 |
| t=0 0 | t=0 0 |
| a=3gpp-FLUS-system:<urn> | a=3gpp-FLUS-system:<urn> |
| m= Audio | m=Audio |
| m=audio 60002 RTP/AVP 127 | m=audio 60002 RTP/AVP 127 |
| b=AS:38 | b=AS38 |
| a=rtpmap:127 EVS/16000 | a=rtpmap:127 EVS/16000 |
| a=ftmp:127 br=5.0-13.2;bw=nb;ch-aw- | a=fmtp:127 br=5.0-13.2;bw=nb;ch-aw- |
| recv=2 | recv=2 |
| ma=3gpp-FLUS-system:AudioInfo | a=3gpp-FLUS-system:AudioInfo |
| SignalType 1 | SignalType 1 |
| a=3gpp-FLUS-system:SignalInfo | a=3gpp-FLUS-system:SignalInfo |
| a=3gpp-FLUS-system:EnvironmentInfo | a=3gpp-FLUS-system:EnvironmentInfo |
| ResponseType 0 | ResponseType 0 |
| a=3gpp-FLUS-system:EnvironmentInfo | a=recvonly |
| ResponseType 1 | a=ptime:20 |
| a=sendonly | a=maxptime:240 |
| a=ptime:20 | |
| a=maxptime:240 | |

TABLE 15

| 2^{nd} SDP offer | 2^{nd} SDP Answer |
|---|---|
| v=0 | v=0 |
| o=user 960 775960 IN IP4 192.168.1.55 | o=user 960 775960 IN IP4 192.168.1.55 |
| s= FLUS | s=FLUS |
| c=IN IP4 192.168.1.55 | c=IN IP4 192.168.1.55 |
| t=0 0 | t=0 0 |
| a=3gpp-FLUS-system:<urn> | a=3gpp-FLUS-system:<urn> |
| m= Audio | m=Audio |
| m=audio 60002 RTP/AVP 127 | m=audio 60002 RTP/AVP 127 |
| b=AS:38 | b=AS38 |
| a=rtpmap:127 EVS/16000 | a=rtpmap:127 EVS/16000 |
| a=ftmp:127 br=5.0-13.2;bw=nb;ch-aw- | a=fmtp:127 br=5.0-13.2;bw=nb;ch-aw- |
| recv=2 | recv=2 |
| ma=3gpp-FLUS-system:AudioInfo | a=3gpp-FLUS-system:AudioInfo |
| SignalType 1 | SignalType 1 |
| a=3gpp-FLUS-system:SignalInfo | a=3gpp-FLUS-system:SignalInfo |
| a=3gpp-FLUS-system:EnvironmentInfo | a=3gpp-FLUS-system:EnvironmentInfo |
| ResponseType 0 | ResponseType 0 |
| a=sendonly | a=recvonly |
| a=ptime:20 | a=ptime:20 |
| a=maxptime:240 | a=maxptime:240 |

Next, Table 16 below shows a negotiation process for a case where two audio bitstreams are transmitted. This is an extended version of a case where only one audio bitstream is transmitted, but the content of the message is not significantly changed. Since multiple audio bitstreams are transmitted at the same time, a=group:FLUS<stream1><stream2> has been added to the message to indicate that two audio bitstreams are grouped. Accordingly, a=mid:stream1 and a=mid:stream2 are added to the end of feature information for transmitting each audio bitstream. In this example, the negotiation process for the audio types supported by the two audio bitstreams is shown, and it can be seen that all the details coincide in the initial negotiation. This example, for simplicity, this example is configured such that the content of the message is coincident from the beginning and thus the negotiation is terminated early. However, when the content of the message is not coincident and a second negotiation needs to be conducted, the message content may be updated in the same manner as in the previous example (Tables 12 to 15).

TABLE 16

| SDP offer | SDP Answer |
|---|---|
| v=0 | v=0 |
| o=user 960 775960 IN IP4 192.168.1.55 | o=user 960 775960 IN IP4 192.168.1.55 |
| s= FLUS | s= FLUS |
| c=IN IP4 192.168.1.55 | c=IN IP4 192.168.1.55 |
| t=0 0 | t=0 0 |
| a=3gpp-FLUS-system:<urn> | a=3gpp-FLUS-system:<urn> |
| m= Audio | m= Audio |
| a=group:FLUS<stream1><stream2> | a=group:FLUS<stream1><stream2> |
| m=audio 60002 RTP/AVP 127 | m=audio 60002 RTP/AVP 127 |
| b=AS:38 | b=AS:38 |
| a=rtpmap:127 EVS/16000 | a=rtpmap:127 EVS/16000 |
| a=ftmp:127 br=5.0-13.2;bw=nb;ch-aw- | a=ftmp:127 br=5.0-13.2;bw=nb;ch-aw- |
| recv=2 | recv=2 |
| ma=3gpp-FLUS-system:AudioInfo | ma=3gpp-FLUS-system:AudioInfo |
| SignalType 1 | SignalType 1 |
| a=3gpp-FLUS-system:SignalInfo | a=3gpp-FLUS-system:SignalInfo |
| a=sendonly | a=sendonly |
| a=ptime:20 | a=ptime:20 |
| a=maxptime: 240 | a=maxptime:240 |
| a=mid:stream | a=mid:stream1 |
| m=audio 60002 RTP/AVP 127 | m=audio 60002 RTP/AVP 127 |
| b=AS:38 | b=AS:38 |
| a=rtpmap:127 EVS/16000 | a=rtpmap:127 EVS/16000 |
| a=ftmp:127 br=5.0-13.2;bw=nb;ch-aw- | a=ftmp:127 br=5.0-13.2;bw=nb;ch-aw- |
| recv=2 | recv=2 |
| ma=3gpp-FLUS-system:AudioInfo | ma=3gpp-FLUS-system:AudioInfo |
| SignalType 1 | SignalType 1 |
| a=3gpp-FLUS-system:SignalInfo | a=3gpp-FLUS-system:SignalInfo |
| a=sendonly | a=sendonly |
| a=ptime:20 | a=ptime:20 |
| a=maxptime:240 | a=maxptime:240 |
| a=mid:stream2 | a=mid:stream2 |

In an embodiment, the SDP messages according to Tables 12 to 16 described above may be modified and signaled according to the HTTP scheme in the case of a non-IMS based FLUS system.

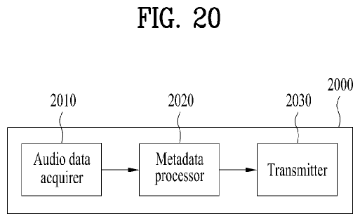

FIG. 19 is a flowchart illustrating a method of operating an audio data transmission apparatus according to an embodiment, and FIG. 20 is a block diagram illustrating the configuration of the audio data transmission apparatus according to the embodiment.

Each operation disclosed in FIG. 19 may be performed by the audio data transmission apparatus disclosed in FIG. 5A or 6A, the FLUS source disclosed in FIGS. 10 to 15, or the audio data transmission apparatus disclosed in FIG. 20. In one example, S1900 of FIG. 19 may be performed by the audio capture terminal disclosed in FIG. 5A, S1910 of FIG. 19 may be performed by the metadata processing terminal disclosed in FIG. 5A, and S1920 of FIG. 19 may be performed by the audio bitstream & metadata packing terminal disclosed in FIG. 5A. Accordingly, in describing each operation of FIG. 19, description of details described with reference to FIGS. 5A, 6A, and 10 to 15 will be omitted or briefly made.

As illustrated in FIG. 20, an audio data transmission apparatus 2000 according to an embodiment may include an audio data acquirer 2010, a metadata processor 2020, and a transmitter 2030. However, in some cases, not all elements shown in FIG. 20 may be mandatory elements of the audio data transmission apparatus 2000, and the audio data transmission apparatus 2000 may be implemented by more or fewer elements than those shown in FIG. 20.

In the audio data transmission apparatus 2000 according to the embodiment, the audio data acquirer 2010, the metadata processor 2020, and the transmitter 2030 may each be implemented as a separate chip, or two or more of the elements may be implemented through one chip.

The audio data transmission apparatus 2000 according to the embodiment may acquire information about at least one audio signal to be subjected to sound information processing (S1900). More specifically, the audio data acquirer 2010 of the audio data transmission apparatus 2000 may acquire information about at least one audio signal to be subjected to sound information processing.

The at least one audio signal may be, for example, a recorded voice, an audio signal acquired by a 360 capture device, or 360 audio data, and is not limited to the above example. In some cases, the at least one audio signal may represent an audio signal prior to sound information processing.

While S1900 limits that at least one audio signal will be subjected to “sound information processing,” the sound information processing may not necessarily be performed on the at least one audio signal. That is, the S1900 should be construed as including an embodiment of acquiring information about at least one audio signal for which “a determination related to the sound information processing is to be performed.”

In S1900, information about at least one audio signal may be acquired in various ways. In one example, the audio data acquirer 2010 may be a capture device, and the at least one audio signal may be captured directly by the capture device. In another example, the audio data acquirer 2010 may be a reception module configured to receive information about an audio signal from an external capture device, and the reception module may receive the information about the at least one audio signal from the external capture device. In another example, the audio data acquirer 2010 may be a reception module configured to receive information about an audio signal from an external user equipment (UE) or a network, and the reception module may receive the information about the at least one audio signal from the external UE or the network. The manner in which the information about the at least one audio signal is acquired may be more diversified by linking the above-described examples and descriptions of FIGS. 18A to 18D.

The audio data transmission apparatus 2000 according to an embodiment may generate metadata about sound information processing based on the information about the at least one audio signal (S1910). More specifically, the metadata processor 2020 of the audio data transmission apparatus 2000 may generate metadata about sound information processing based on the information about the at least one audio signal.

The metadata about sound information processing represents the metadata about sound information processing described after the description of FIG. 18D in the present disclosure. It will be readily understood by those skilled in the art that the “metadata about sound information processing” in S1910 is the same as/similar to the “metadata about sound information processing described after the description of FIG. 18D in the present disclosure,” or a concept including the metadata about sound information processing described after the description of FIG. 18D in the present disclosure, or a concept included in the metadata about sound information processing described after the description of FIG. 18D in the present disclosure.

In an embodiment, the metadata about sound information processing may contain sound environment information including information on a space for the at least one audio signal and information on both ears of at least one user of the audio data reception apparatus. In one example, the sound environment information may be indicated by EnvironmentInfoType.

In an embodiment, the information on both ears of the at least one user included in the sound environment information may include information on the total number of the at least one user, and identification (ID) information on each of the at least one user and information on both ears of each of the at least one user. In an example, the information on the total number of the at least one user may be indicated by @NumOfPersonalInfo, and the ID information on each of the at least one user may be indicated by PersonalID.

In an embodiment, the information on both ears of each of the at least one user may include at least one of head width information, cavum concha length information, cymba concha length information, and fossa length information, pinna length and angle information, or intertragal incisures length information on each of the at least one user. In one example, the head length information on each of the at least one user may be indicated by @Head width, the cavum concha length information may be indicated by @Cavum concha height and @Cavum concha width, and the cymba concha length information may be indicated by @Cymba concha height, the fossa length information may be indicated by @Fossa height, the pinna length and angle information may be indicated by @Pinna height, @Pinna width, @Pinna rotation angle, and @Pinna flare angle, and the intertragal incisures length information may be indicated by @Intertragal incisures width.

In an embodiment, the information on the space for the at least one audio signal included in the sound environment information may include information on the number of at least one response related to the at least one audio signal, ID information on each of the at least one response and characteristics information on each of the at least one response. In an example, the information on the number of the at least one response related to the at least one audio signal may be indicated by @NumOfResponses, and the ID information on each of the at least one response may be indicated by ResponseID.

In an embodiment, the characteristics information on each of the at least one response includes azimuth information, elevation information, and distance information on a space corresponding to each of the at least one response, information about whether to apply a binaural room impulse response (BRIR) to the at least one response, characteristics information on the BRIR, or characteristics information on a room impulse response (RIR). In one example, the azimuth information on the space corresponding to each of the at least one response may be indicated by @RespAzimuth, the elevation information may be indicated by @RespElevation, the distance information may be indicated by @RespDistance, the information about whether to apply the BRIR to the at least one response may be indicated by @IsBRIR, the characteristics information on the BRIR may be indicated by BRIRInfo, and the characteristics information on the RIR may be indicated by RIRInfo.

In an embodiment, the metadata about the sound information processing may contain sound capture information, related information according to the type of an audio signal, and characteristics information on the audio signal. In one example, the sound capture information may be indicated by CaptureInfo, the related information according to the type of the audio signal may be indicated by AudioInfoType, and the characteristics information on the audio signal may be indicated by SignalInfoType.

In an embodiment, the sound capture information may include at least one of information on at least one microphone array used to capture the at least one audio signal or at least one voice, information on at least one microphone included in the at least one microphone array, information on a unit time considered in capturing the at least one audio signal, or microphone parameter information on each of the at least one microphone included in the at least one microphone array. In one example, the information on the at least one microphone array used to capture the at least one audio signal may include @NumOfMicArray, MicArrayID, @CapturedSignalType, and @NumOfMicPerMicArray, and the information on the at least one microphone included in the at least one microphone array may include MicID, @MicPosAzimuth, @MicPosElevation, @MicPosDistance, @SamplingRate, @AudioFormat, and @Duration. The information on the unit time considered in capturing the at least one audio signal may include @NumOfUnitTime, @UnitTime, UnitTimeldx, @PosAzimuthPerUnitTime, @PosElevationPerUnitTime, and @PosDistancePerUnitTime, and the microphone parameter information on each of the at least one microphone included in the at least one microphone array may be indicated by MicParams. MicParams may include @TransducerPrinciple, @MicType, @DirectRespType, @FreeFieldSensitivity, @PoweringType, @PoweringVoltage, @PoweringCurrent, @FreqResponse, @Min FreqResponse, @Max FreqResponse, @InternalImpedance, @RatedImpedance, @MinloadImpedance, @DirectivityIndex, @PercentofTHD, @DBofTHD, @OverloadSoundPressure, and @InterentNoise.

In an embodiment, the related information according to the type of the audio signal may include at least one of information on the number of the at least one audio signal, ID information on the at least one audio signal, information on a case where the at least one audio signal is a channel signal, or information on a case where the at least one audio signal is an object signal. In one example, the information on the number of the at least one audio signal may be indicated by @NumOfAudioSignals, and the ID information on the at least one audio signal may be indicated by AudioSignalID.

In an embodiment, the information on the case where the at least one audio signal is the channel signal may include information on a loudspeaker, and the information on the case where the at least one audio signal is the object signal may include information on @NumOfObject, ObjectID, and object location information. In one example, the information on the loudspeaker may include @NumOfLoudSpeakers, LoudSpeakerID, @Coordinate System, and information on the location of the loudspeaker.

In an embodiment, the characteristics information on the audio signal may include at least one of type information, format information, sampling rate information, bit size information, start time information, and duration information on the audio signal. In one example, the type information on the audio signal may be indicated by @SignalType, the format information may be indicated by @FormatType, the sampling rate information may be indicated by @SamplingRate, the bit size information may be indicated by @BitSize, and the start time information and duration information may be indicated by @StartTime and @Duration.

The audio data transmission apparatus 2000 according to an embodiment may transmit metadata about sound information processing to an audio data reception apparatus (S1920). More specifically, the transmitter 2030 of the audio data transmission apparatus 2000 may transmit the metadata about sound information processing to the audio data reception apparatus.

In an embodiment, the metadata about sound information processing may be transmitted to the audio data reception apparatus based on an XML format, a JSON format, or a file format.

In an embodiment, transmission of the metadata by the audio data transmission apparatus 2000 may be an uplink (UL) transmission based on a Framework for Live Uplink Streaming (FLUS) system.

The transmitter 2030 according to an embodiment may be a concept including an F-interface, an F-C, an F-U, an F reference point, and a packet-based network interface described above. In one embodiment, the audio data transmission apparatus 2000 and the audio data reception apparatus may be separate devices. The transmitter 2030 may be present inside the audio data transmission apparatus 2000 as an independent module. In another embodiment, although the audio data transmission apparatus 2000 and the audio data reception apparatus are separate devices, the transmitter 2030 may not be divided into a transmitter for the audio data transmission apparatus 2000 and a transmitter for the audio data reception apparatus, but may be interpreted as being shared by the audio data transmission apparatus 2000 and the audio data reception apparatus. In another embodiment, the audio data transmission apparatus 2000 and the audio data reception apparatus are combined to form one (audio data transmission) apparatus 2000, and the transmitter 2030 may be present in the one (audio data transmission) apparatus 2000. However, operation of the network transmitter 2030 is not limited to the above-described examples or the above-described embodiments.

In one embodiment, the audio data transmission apparatus 2000 may receive metadata about sound information processing from the audio data reception apparatus, and may generate metadata about the sound information processing based on the metadata about sound information processing received from the audio data reception apparatus. More specifically, the audio data transmission apparatus 2000 may receive information (metadata) about audio data processing of the audio data reception apparatus from the audio data reception apparatus, and generate metadata about sound information processing based on the received information (metadata) about the audio data processing of the audio data reception apparatus. Here, the information (metadata) about the audio data processing of the audio data reception apparatus may be generated by the audio data reception apparatus based on the metadata about the sound information processing received from the audio data transmission apparatus 2000.

According to the audio data transmission apparatus 2000 and the method of operating the audio data transmission apparatus 2000 disclosed in FIGS. 19 and 20, the audio data transmission apparatus 2000 may acquire information about at least one audio signal to be subjected to sound information processing (S1900), generate metadata about the sound information processing based on the information about the at least one audio signal (S1910), and transmit the metadata about the sound information processing to an audio data reception apparatus (S1920). When S1900 to S1920 are applied in the FLUS system, the audio data transmission apparatus 2000, which is a FLUS source, may efficiently deliver the metadata about the sound information processing to the audio data reception apparatus, which is a FLUS sink, through uplink (UL) transmission. Accordingly, in the FLUS system, the FLUS source may efficiently deliver media information of 3DoF or 3DoF+ to the FLUS sink through UL transmission (and 6DoF media information may also be transmitted, but embodiments are not limited thereto).

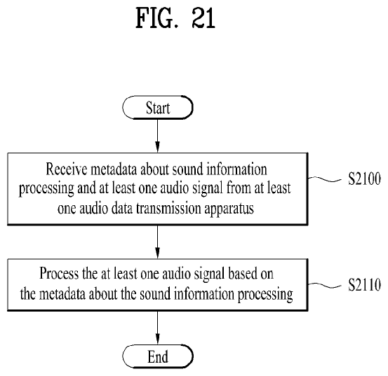

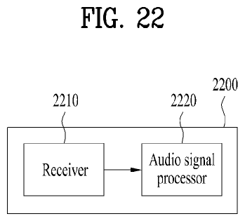

FIG. 21 is a flowchart illustrating a method of operating an audio data reception apparatus according to an embodiment, and FIG. 22 is a block diagram illustrating the configuration of the audio data reception apparatus according to the embodiment.

The audio data reception apparatus 2200 according to FIGS. 21 and 22 may perform operations corresponding to the audio data transmission apparatus 2000 according to FIGS. 19 and 20 described above. Accordingly, details described with reference to FIGS. 19 and 20 may be partially omitted from the description of FIGS. 21 and 22.

Each of the operations disclosed in FIG. 21 may be performed by the audio data reception apparatus disclosed in FIG. 5B or 6B, the FLUS sink disclosed in FIGS. 10 to 15, or the audio data transmitting apparatus disclosed in FIG. 22. Accordingly, in describing each operation of FIG. 21, description of details which are the same as those described above with reference to FIGS. 5B, 6B, and 10 to 15 will be omitted or simplified.

As illustrated in FIG. 22, the audio data reception apparatus 2200 according to an embodiment may include a receiver 2210 and an audio signal processor 2220. However, in some cases, not all elements shown in FIG. 22 may be mandatory elements of the audio data reception apparatus 2200. The audio data reception apparatus 2200 may be implemented by more or fewer elements than those shown in FIG. 30.

In the audio data reception apparatus 2200 according to the embodiment, the receiver 2210 and the audio signal processor 2220 may be implemented as separate chips, or at least two elements may be implemented through one chip.

The audio data reception apparatus 2200 according to an embodiment may receive metadata about sound information processing and at least one audio signal from at least one audio data transmission apparatus (S2100). More specifically, the receiver 2210 of the audio data reception apparatus 2200 may receive the metadata about sound information processing and the at least one audio signal from the at least one audio data transmission apparatus.

The audio data reception apparatus 2200 according to the embodiment may process the at least one audio signal based on the metadata about sound information processing (S2110). More specifically, the audio signal processor 2220 of the audio data reception apparatus 2200 may process the at least one audio signal based on the metadata about sound information processing.

In one embodiment, the metadata about sound information processing may contain sound environment information including information on a space for the at least one audio signal and information on both ears of at least one user of the audio data reception apparatus.

According to the audio data reception apparatus 2200 and the method of operating the audio data reception apparatus 2200 disclosed in FIGS. 21 and 22, the audio data reception apparatus 2200 may receive metadata about sound information processing and at least one audio signal from at least one audio data transmission apparatus (S2100), and process the at least one audio signal based on the metadata about sound information processing (S2110). When S2100 and S2110 are applied in the FLUS system, the audio data reception apparatus 2200, which is a FLUS sink, may receive the metadata about the sound information processing transmitted from the audio data transmission apparatus 2000, which is a FLUS source, through uplink. Accordingly, in the FLUS system, the FLUS sink may efficiently receive 3DoF or 3DoF+ media information from the FLUS source through uplink transmission of the FLUS source (and 6DoF media information may also be transmitted, but embodiments are not limited thereto).

When a 360-degree audio streaming service is provided over a network, information necessary for processing an audio signal may be signaled through uplink. Since the information is information considering processes from the capture process to the rendering process, audio signals may be reconstructed based on the information at a point in time according to the user's convenience. In general, basic audio processing is performed after capturing audio, and the intention of the content creator may be added in this process. However, according to an embodiment of the present disclosure, the capture information, which is separately transmitted, allows the service user to selectively generate an audio signal of a type (e.g., channel type, object type, etc.) from the captured sound, and accordingly the degree of freedom may be increased. In addition, to provide a 360-degree audio streaming service, necessary information may be exchanged between the source and the sink The information may include all information for 360-degree audio, including information about the capture process and the necessary information for rendering. Accordingly, when necessary, information required by the sink may be generated and delivered. In one example, when the source has a captured sound and the sink requires a 5.1 multi-channel signal, the source generate a 5.1 multi-channel signal by directly performing audio processing and transmits the same to the sink, or may deliver the captured sound to the sink such that the sink may generate a 5.1 multi-channel signal. Additionally, SIP signaling for negotiation between the source and the sink may be performed for the 360-degree audio streaming service.

Each of the above-described parts, modules, or units may be a processor or hardware part that executes successive procedures stored in a memory (or storage unit). Each of the operations described in the above-described embodiments may be performed by processors or hardware parts. Each module/block/unit described in the above-described embodiments may operate as a hardware element/processor. In addition, the methods described in the present disclosure may be executed as code. The code may be written in a recoding medium readable by a processor, and thus may be read by the processor provided by the apparatus.

While the methods in the above-described embodiments are described based on a flowchart of a series of operations or blocks, the present disclosure is not limited to the order of the operations. Some operations may take place in a different order or simultaneously. It will be understood by those skilled in the art that the operations shown in the flowchart are not exclusive, and other operations may be included or one or more of the operations in the flowchart may be omitted within the scope of the present disclosure.

When embodiments of the present disclosure are implemented in software, the above-described methods may be implemented as modules (processes, function, etc.) configured to perform the above-described functions. The module may be stored in a memory and may be executed by a processor. The memory may be inside or outside the processor, and may be connected to the processor by various well-known means. The processor may include application-specific integrated circuits (ASICs), other chipsets, logic circuits, and/or data processing devices. The memory may include a read-only memory (ROM), a random access memory (RAM), a flash memory, a memory card, a storage medium, and/or other storage devices.

The internal elements of the above-described apparatuses may be processors that execute successive processes stored in the memory, or may be hardware elements composed of other hardware. These elements may be arranged inside/outside the device.

The above-described modules may be omitted or replaced by other modules configured to perform similar/same operations according to embodiments.

1. A method for transmitting media streams based on a Framework for Live Uplink Streaming (FLUS) system, the method comprising:
capturing audio data;
encoding the captured audio data;
generating metadata for the captured audio data, the metadata including information about a 3D space for the captured audio data; and
transmitting the media streams including the encoded audio data and the generated metadata.

2. The method of claim 1, wherein the metadata contains sound source environment information comprising information on a space for the audio data and information on both ears of at least one user of an audio data reception apparatus.

3. The method of claim 2, wherein the information on both ears of the at least one user included in the sound source environment information comprises information on a total number of the at least one user, identification (ID) information on each of the at least one user, and information on both ears of each of the at least one user.

4. The method of claim 3, wherein the information on both ears of each of the at least one user comprises at least one of head width information, cavity concha length information, cymba concha length information, and fossa length information, pinna length and angle information, or intertragal incisures length information on each of the at least one user.

5. The method of claim 2, wherein the information on the space for the audio data included in the sound source environment information comprises:
information on the number of at least one response related to the audio data;
identification (ID) information on each of the at least one response; and
characteristics information on each of the at least one response.

6. The method of claim 5, wherein the characteristics information on each of the at least one response comprises at least one of azimuth information on a space corresponding to each of the at least one response, elevation information on the space, distance information on the space, information indicating whether to apply a binaural room impulse response (BRIR) to the at least one response, characteristics information on the BRIR, or characteristics information on a room impulse response (RIR).

7. The method of claim 1, wherein the metadata further contains sound capture information, type information for the audio data or characteristics information on the audio data and the audio data includes a 3D audio data.

8. The method of claim 7, wherein the sound capture information comprises at least one of:
information on at least one microphone array used in capturing the audio data;
information on at least one microphone included in the at least one microphone array; and
information on a unit time considered in capturing the audio data or microphone parameter information on each of the at least one microphone included in the at least one microphone array.

9. The method of claim 7, wherein the related information according to the type of the audio data comprises at least one of:
information on a number of the audio data;
identification (ID) on the audio data; and
information on a case where the audio data is a channel signal or information on a case where the audio data is an object signal.

10. The method of claim 9,
wherein the information on the case where the audio data is the channel signal comprises information on a loudspeaker, and
wherein the information on the case where the audio data is the object signal comprises object location information.

11. The method of claim 7, wherein the characteristics information on the audio data comprises at least one of type information, format information, sampling rate information, bit size information, start time information, or duration information on the audio signal.

12. The method of claim 1, wherein the metadata is transmitted to an audio data reception apparatus based on an XML format, a JSON format or a file format.

13-15. (canceled)

16. Media streams transmission apparatus based on a Framework for Live Uplink Streaming (FLUS) system, the apparatus comprising:
a capturing device configured to capturing audio data;
an encoder configured to encode the captured audio data;
a metadata generator configured to generated metadata for the captured audio data, the metadata including information about a 3D space for the captured audio data; and
a transmitter configured to transmit the media streams including the encoded audio data and the generated metadata.

17. A method for receiving media streams including an encoded audio data and metadata based on a Framework for Live Uplink Streaming (FLUS) system, the method comprising:
parsing the metadata for the audio data, the metadata including information about a 3D space for the audio data; and
decoding the audio data based on the parsed metadata.
